(19) United States
(12) Patent Application Publication
(10) Pub. No.: US 2026/0050476 A1
(43) Pub. Date: Feb. 19, 2026

(54) TASK SPECIFIC MODELS FOR WIRELESS NETWORKS

(71) Applicant: Nokia Technologies Oy, Espoo (FI)

(72) Inventors: Oana-Elena BARBU, Aalborg (DK); István Zsolt KOVÁCS, Aalborg (DK); Luis Guilherme UZEDA GARCIA, Massy (FR); Rustam PIRMAGOMEDOV, Oulu (FI)

(21) Appl. No.: 19/100,713

(22) PCT Filed: Aug. 3, 2022
(86) PCT No.: PCT/EP2022/071844

§ 371 Date: Feb. 3, 2025

(51) Int. Cl. G06F 9/50

(52) U.S. Cl. CPC G06F 9/5027

(57) ABSTRACT

According to an example embodiment, a method may include receiving, by a user equipment from a network node, a request for a sub-task specific model, including configuration parameters for the sub-task specific model, wherein the sub-task specific model is to perform or assist with performing a machine learning-enabled sub-constraints task; verifying the request for the sub-task specific model; modifying, by the user equipment, the sub-task specific model based on the trained generic model and the configuration parameters of the sub-task or the sub-task specific model; performing or executing, by the user equipment, a machine learning-enabled sub-task based on or using the modified sub-task specific model; and transmitting, by the user equipment to the network node, sub-task specific model outputs based on the performing or executing the machine learning-enabled sub-task based on or using the modified sub-task specific model.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G and 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

According to an example embodiment, a method may include receiving, by a first model training unit from a second model training unit, a trigger indication to trigger or cause modifying of a sub-task specific model, an indication of a generic model trained by the second model training unit for a generic task, and one or more parameters of a sub-task or the sub-task specific model to be used for modifying the sub-task specific model based on the generic model, wherein the sub-task specific model is to perform or assist with performing a machine learning-enabled sub-task; receiving, by the first model training unit from one or more sub-task specific model collectors, training data for the sub-task specific model; modifying, by the first model training unit, the sub-task specific model based on the generic model, the one or more parameters of the sub-task or the sub-task specific model, and the training data received from the one or more sub-task specific model collectors; and transmitting, by the first model training unit to a first wireless node, the modified sub-task specific model.

According to an example embodiment, an apparatus may include: at least one processor; and at least one memory including computer program code; the at least one memory and the computer program code configured to, with the at least one processor, cause the apparatus at least to: receive, by a first model training unit from a second model training unit, a trigger indication to trigger or cause modifying of a sub-task specific model, an indication of a generic model trained by the second model training unit for a generic task, and one or more parameters of a sub-task or the sub-task specific model to be used for modifying the sub-task specific model based on the generic model, wherein the sub-task specific model is to perform or assist with performing a machine learning-enabled sub-task; receive, by the first model training unit from one or more sub-task specific model collectors, training data for the sub-task specific model; modify, by the first model training unit, the sub-task specific model based on the generic model, the one or more parameters of the sub-task or the sub-task specific model, and the training data received from the one or more sub-task specific model collectors; and transmit, by the first model training unit to a first wireless node, the modified sub-task specific model.

According to an example embodiment, an apparatus may include means for receiving, by a first model training unit from a second model training unit, a trigger indication to trigger or cause modifying of a sub-task specific model, an indication of a generic model trained by the second model training unit for a generic task, and one or more parameters of a sub-task or the sub-task specific model to be used for modifying the sub-task specific model based on the generic model, wherein the sub-task specific model is to perform or assist with performing a machine learning-enabled sub-task; means for receiving, by the first model training unit from one or more sub-task specific model collectors, training data for the sub-task specific model; means for modifying, by the first model training unit, the sub-task specific model based on the generic model, the one or more parameters of the sub-task or the sub-task specific model, and the training data received from the one or more sub-task specific model collectors; and means for transmitting, by the first model training unit to a first wireless node, the modified sub-task specific model.

According to an example embodiment, a non-transitory computer-readable storage medium may include instructions stored thereon that, when executed by at least one processor, are configured to cause a computing system to receive, by a first model training unit from a second model training unit, a trigger indication to trigger or cause modifying of a sub-task specific model, an indication of a generic model trained by the second model training unit for a generic task, and one or more parameters of a sub-task or the sub-task specific model to be used for modifying the sub-task specific model based on the generic model, wherein the sub-task specific model is to perform or assist with performing a machine learning-enabled sub-task; receive, by the first model training unit from one or more sub-task specific model collectors, training data for the sub-task specific model; modify, by the first model training unit, the sub-task specific model based on the generic model, the one or more parameters of the sub-task or the sub-task specific model, and the training data received from the one or more sub-task specific model collectors; and transmit, by the first model training unit to a first wireless node, the modified sub-task specific model.

According to an example embodiment, a method may include receiving a request for, or otherwise determining a need for, modifying of a sub-task specific model for a first wireless node based on a generic model, wherein the sub-task specific model is to perform or assist with performing a machine learning-enabled sub-task; transmitting, by a second model training unit to a first model training unit, a trigger indication to trigger or cause modifying of a sub-task specific model by the first model training unit, an indication of the generic model trained by the second model training unit for a generic task, and one or more parameters of a sub-task or a sub-task specific model to be used for modifying the sub-task specific model based on the generic model; configuring, by the second model training unit, one or more sub-task specific model collectors to provide training data to the first model training unit for modifying the sub-task specific model; and receiving, by the second model training unit from the first model training unit, the modified sub-task specific model that was modified by the first model training unit.

An apparatus may include: at least one processor; and at least one memory including computer program code; the at least one memory and the computer program code configured to, with the at least one processor, cause the apparatus at least to: receive a request for, or otherwise determining a need for, modifying of a sub-task specific model for a first wireless node based on a generic model, wherein the sub-task specific model is to perform or assist with performing a machine learning-enabled sub-task; transmit, by a second model training unit to a first model training unit, a trigger indication to trigger or cause modifying of a sub-task specific model by the first model training unit, an indication of the generic model trained by the second model training unit for a generic task, and one or more parameters of a sub-task or a sub-task specific model to be used for modifying the sub-task specific model based on the generic model; configure, by the second model training unit, one or more sub-task specific model collectors to provide training data to the first model training unit for modifying the sub-task specific model; and receive, by the second model training unit from the first model training unit, the modified sub-task specific model that was modified by the first model training unit.

According to an example embodiment, an apparatus may include means for receiving a request for, or otherwise determining a need for, modifying of a sub-task specific model for a first wireless node based on a generic model, wherein the sub-task specific model is to perform or assist with performing a machine learning-enabled sub-task; means for transmitting, by a second model training unit to a first model training unit, a trigger indication to trigger or cause modifying of a sub-task specific model by the first model training unit, an indication of the generic model trained by the second model training unit for a generic task, and one or more parameters of a sub-task or a sub-task specific model to be used for modifying the sub-task specific model based on the generic model; means for configuring, by the second model training unit, one or more sub-task specific model collectors to provide training data to the first model training unit for modifying the sub-task specific model; and means for receiving, by the second model training unit from the first model training unit, the modified sub-task specific model that was modified by the first model training unit.

According to an example embodiment, a non-transitory computer-readable storage medium may include instructions stored thereon that, when executed by at least one processor, are configured to cause a computing system to: receive a request for, or otherwise determining a need for, modifying of a sub-task specific model for a first wireless node based on a generic model, wherein the sub-task specific model is to perform or assist with performing a machine learning-enabled sub-task; transmit, by a second model training unit to a first model training unit, a trigger indication to trigger or cause modifying of a sub-task specific model by the first model training unit, an indication of the generic model trained by the second model training unit for a generic task, and one or more parameters of a sub-task or a sub-task specific model to be used for modifying the sub-task specific model based on the generic model; configure, by the second model training unit, one or more sub-task specific model collectors to provide training data to the first model training unit for modifying the sub-task specific model; and receive, by the second model training unit from the first model training unit, the modified sub-task specific model that was modified by the first model training unit.

According to an example embodiment, a method may include determining, by a user equipment, a trained generic model to perform or assist with performing a machine learning-enabled generic task; determining, based on the trained generic model, one or more generic model-based outputs based on one or more signals or inputs; transmitting, by the user equipment to a network node, the one or more generic model-based outputs; receiving, by the user equipment from the network node based at least in part on the one or more generic model-based outputs, a request for a sub-task specific model, including configuration parameters for the sub-task specific model, wherein the sub-task specific model is to perform or assist with performing a machine learning-enabled sub-task; verifying the request for the sub-task specific model; modifying, by the user equipment, the sub-task specific model based on the trained generic model and the configuration parameters of the sub-task or the sub-task specific model; and performing or executing, by the user equipment, a machine learning-enabled sub-task based on or using the modified sub-task specific model; and transmitting, by the user equipment to the network node, sub-task specific model outputs based on the performing or executing the machine learning-enabled sub-task based on or using the modified sub-task specific model.

An apparatus may include: at least one processor; and at least one memory including computer program code; the at least one memory and the computer program code configured to, with the at least one processor, cause the apparatus at least to: determine, by a user equipment, a trained generic model for performing or assist with performing a generic machine learning-enabled task; determine, based on the trained generic model, one or more generic model-based outputs based on one or more signals or inputs; transmit, by the user equipment to a network node, the one or more generic model-based outputs; receive, by the user equipment from the network node based at least in part of the one or more generic model-based outputs, a request for a sub-task specific model, including configuration parameters for the sub-task specific model, wherein the sub-task specific model is to perform or assist with performing a machine learning-enabled sub-task; verify the request for the sub-task specific model; modify, by the user equipment, the sub-task specific model based on the trained generic model and the configuration parameters of the sub-task or the sub-task specific model; perform or execute, by the user equipment, a machine learning-enabled sub-task based on or using the modified sub-task specific model; and transmit, by the user equipment to the network node, sub-task specific model outputs based on the performing or executing the machine learning-enabled sub-task based on or using the trained sub-task specific model.

According to an example embodiment, an apparatus may include means for determining, by a user equipment, a trained generic model to perform or assist with performing a machine learning-enabled generic task; means for determining, based on the trained generic model, one or more generic model-based outputs based on one or more signals or inputs; means for transmitting, by the user equipment to a network node, the one or more generic model-based outputs; means for receiving, by the user equipment from the network node based at least in part on the one or more generic model-based outputs, a request for a sub-task specific model, including configuration parameters for the sub-task specific model, wherein the sub-task specific model is to perform or assist with performing a machine learning-enabled sub-task; means for verifying the request for the sub-task specific model; means for modifying, by the user equipment, the sub-task specific model based on the trained generic model and the configuration parameters of the sub-task or the sub-task specific model; and means for performing or executing, by the user equipment, a machine learning-enabled sub-task based on or using the modified sub-task specific model; and means for transmitting, by the user equipment to the network node, sub-task specific model outputs based on the performing or executing the machine learning-enabled sub-task based on or using the modified sub-task specific model.

According to an example embodiment, a non-transitory computer-readable storage medium may include instructions stored thereon that, when executed by at least one processor, are configured to cause a computing system to: determine, by a user equipment, a trained generic model for performing or assist with performing a generic machine learning-enabled task; determine, based on the trained generic model, one or more generic model-based outputs based on one or more signals or inputs; transmit, by the user equipment to a network node, the one or more generic model-based outputs; receive, by the user equipment from the network node based at least in part of the one or more generic model-based outputs, a request for a sub-task specific model, including configuration parameters for the sub-task specific model, wherein the sub-task specific model is to perform or assist with performing a machine learning-enabled sub-task; verify the request for the sub-task specific model; modify, by the user equipment, the sub-task specific model based on the trained generic model and the configuration parameters of the sub-task or the sub-task specific model; perform or execute, by the user equipment, a machine learning-enabled sub-task based on or using the modified sub-task specific model; and transmit, by the user equipment to the network node, sub-task specific model outputs based on the performing or executing the machine learning-enabled sub-task based on or using the trained sub-task specific model.

According to an example embodiment, a method may include determining, by a network node, a trained generic model to perform or assist with performing a machine learning-enabled generic task; providing, by the network node to a user equipment, the trained generic model; receiving, by the network node from the user equipment, a request for a sub-task specific model; verifying the request for the sub-task specific model; transmitting, by the network node to the user equipment, a request for at least one of sub-task specific model configuration or constraints and/or sub-task specific model training data; receiving, by the network node from the user equipment, at least one of sub-task specific model configuration or constraints and/or sub-task specific model training data; modifying, by the network node, the sub-task specific model based on the generic model, and at least one of the sub-task specific model configuration or constraints and/or sub-task specific model training data; and transmitting, by the network node to the user equipment, the modified sub-task specific model.

An apparatus may include: at least one processor; and at least one memory including computer program code; the at least one memory and the computer program code configured to, with the at least one processor, cause the apparatus at least to: determine, by a network node, a trained generic model to perform or assist with performing a machine learning-enabled generic task; provide, by the network node to a user equipment, the trained generic model; receive, by the network node from the user equipment, a request for a sub-task specific model; verify the request for the sub-task specific model; transmit, by the network node to the user equipment, a request for at least one of sub-task specific model configuration or constraints and/or sub-task specific model training data; receive, by the network node from the user equipment, at least one of sub-task specific model configuration or constraints and/or sub-task specific model training data; modify, by the network node, the sub-task specific model based on the generic model, and at least one of the sub-task specific model configuration or constraints and/or sub-task specific model training data; and transmit, by the network node to the user equipment, the modified sub-task specific model.

According to an example embodiment, an apparatus may include means for determining, by a network node, a trained generic model to perform or assist with performing a machine learning-enabled generic task; means for providing, by the network node to a user equipment, the trained generic model; receiving, by the network node from the user equipment, a request for a sub-task specific model; means for verifying the request for the sub-task specific model; transmitting, by the network node to the user equipment, a request for at least one of sub-task specific model configuration or constraints and/or sub-task specific model training data; means for receiving, by the network node from the user equipment, at least one of sub-task specific model configuration or constraints and/or sub-task specific model training data; means for modifying, by the network node, the sub-task specific model based on the generic model, and at least one of the sub-task specific model configuration or constraints and/or sub-task specific model training data; and means for transmitting, by the network node to the user equipment, the modified sub-task specific model.

According to an example embodiment, a non-transitory computer-readable storage medium may include instructions stored thereon that, when executed by at least one processor, are configured to cause a computing system to: determine, by a network node, a trained generic model to perform or assist with performing a machine learning-enabled generic task; provide, by the network node to a user equipment, the trained generic model; receive, by the network node from the user equipment, a request for a sub-task specific model; verify the request for the sub-task specific model; transmit, by the network node to the user equipment, a request for at least one of sub-task specific model configuration or constraints and/or sub-task specific model training data; receive, by the network node from the user equipment, at least one of sub-task specific model configuration or constraints and/or sub-task specific model training data; modify, by the network node, the sub-task specific model based on the generic model, and at least one of the sub-task specific model configuration or constraints and/or sub-task specific model training data; and transmit, by the network node to the user equipment, the modified sub-task specific model.

According to an example embodiment, a method may include determining, by a network node, a trained generic model to perform or assist with performing a machine learning-enabled generic task; providing, by the network node to a user equipment, the trained generic model; receiving, by the network node from the user equipment, a request for a sub-task specific model; verifying the request for the sub-task specific model; transmitting, by the network node to the user equipment, a request for at least one of sub-task specific model configuration or constraints and/or sub-task specific model training data; receiving, by the network node from the user equipment, at least one of sub-task specific model configuration or constraints and/or sub-task specific model training data; modifying, by the network node, the sub-task specific model based on the generic model, and at least one of the sub-task specific model configuration or constraints and/or sub-task specific model training data; and transmitting, by the network node to the user equipment, the modified sub-task specific model.

An apparatus may include: at least one processor; and at least one memory including computer program code; the at least one memory and the computer program code configured to, with the at least one processor, cause the apparatus at least to: determine, by a network node, a trained generic model to perform or assist with performing a machine learning-enabled generic task; provide, by the network node to a user equipment, the trained generic model; receive, by the network node from the user equipment, a request for a sub-task specific model; verify the request for the sub-task specific model; transmit, by the network node to the user equipment, a request for at least one of sub-task specific model configuration or constraints and/or sub-task specific model training data; receive, by the network node from the user equipment, at least one of sub-task specific model configuration or constraints and/or sub-task specific model training data; modify, by the network node, the sub-task specific model based on the generic model, and at least one of the sub-task specific model configuration or constraints and/or sub-task specific model training data; and transmit, by the network node to the user equipment, the modified sub-task specific model.

According to an example embodiment, an apparatus may include means for determining, by a network node, a trained generic model to perform or assist with performing a machine learning-enabled generic task; means for providing, by the network node to a user equipment, the trained generic model; receiving, by the network node from the user equipment, a request for a sub-task specific model; means for verifying the request for the sub-task specific model; transmitting, by the network node to the user equipment, a request for at least one of sub-task specific model configuration or constraints and/or sub-task specific model training data; means for receiving, by the network node from the user equipment, at least one of sub-task specific model configuration or constraints and/or sub-task specific model training data; means for modifying, by the network node, the sub-task specific model based on the generic model, and at least one of the sub-task specific model configuration or constraints and/or sub-task specific model training data; and means for transmitting, by the network node to the user equipment, the modified sub-task specific model.

According to an example embodiment, a non-transitory computer-readable storage medium may include instructions stored thereon that, when executed by at least one processor, are configured to cause a computing system to: determine, by a network node, a trained generic model to perform or assist with performing a machine learning-enabled generic task; provide, by the network node to a user equipment, the trained generic model; receive, by the network node from the user equipment, a request for a sub-task specific model; verify the request for the sub-task specific model; transmit, by the network node to the user equipment, a request for at least one of sub-task specific model configuration or constraints and/or sub-task specific model training data; receive, by the network node from the user equipment, at least one of sub-task specific model configuration or constraints and/or sub-task specific model training data; modify, by the network node, the sub-task specific model based on the generic model, and at least one of the sub-task specific model configuration or constraints and/or sub-task specific model training data; and transmit, by the network node to the user equipment, the modified sub-task specific model.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a flow chart illustrating operation of a model training unit according to an example embodiment.

FIG. 3 is a flow chart illustrating operation of a second model training unit according to an example embodiment.

FIG. 4 is a flow chart illustrating operation of a user equipment according to an example embodiment.

FIG. 5 is a flow chart illustrating operation of a network node (e.g., gNB) according to an example embodiment.

FIG. 6 is a diagram illustrating operation of a generic model training unit (GMTU) and a meta-learning model training unit (MMTU) or specific model training unit according to an example embodiment.

FIG. 7 is a diagram of a network in which generic model (GM) training and sub-task specific model (SSM) training are performed at a network node according to an example embodiment.

FIG. 8 is a diagram of a network in which generic model (GM) training and sub-task specific model (SSM) training are performed at a UE or user device.

FIG. 9 is a block diagram of a wireless station or wireless node (e.g., network node, user node or UE, relay node, or other node).

### DETAILED DESCRIPTION

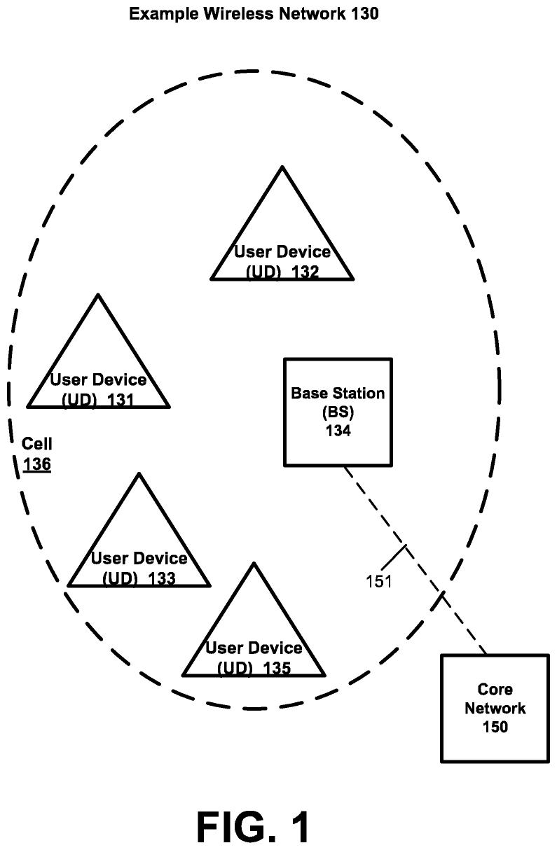

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a gNB or a network node. The terms user device and user equipment (UE) may be used interchangeably. A BS (or network node) may also include or may be referred to as a RAN (radio access network) node, and may include a portion of a BS or a portion of a RAN node, such as (e.g., such as a centralized unit (CU) and/or a distributed unit (DU) in the case of a split BS or split gNB). At least part of the functionalities of a BS (e.g., access point (AP), base station (BS) or (e)Node B (eNB), gNB, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a S1 interface 151. This is merely one simple example of a wireless network, and others may be used. A wireless node may include, e.g., a BS, a gNB, an eNB, an AP, a RAN node, a CU and/or DU (or other network node), a relay node, a user device, a UE, or other node that has wireless communication capabilities, etc.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a /centralized unit (CU) and/or a distributed unit (DU) in the case of a split BS or split gNB), or other network node.

According to an illustrative example, a BS node or other network node (e.g., BS, eNB, gNB, CU/DU, transmission reception point (TRP), . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node or network node (e.g., BS, eNB, gNB, CU/DU, . . . ) may forward data to the UE that is received from a network or the core network, and/or forward data received from the UE to the network or core network. RAN nodes or network nodes (e.g., BS, eNB, gNB, CU/DU, . . . ) may perform a wide variety of other wireless functions or services, e.g., such as broadcasting control information (e.g., such as system information or on-demand system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform.

A user device or user node (user terminal, user equipment (UE), mobile terminal, handheld wireless device, etc.) may refer to a portable computing device that includes wireless mobile communication devices operating either with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. Also, a user node may include a user equipment (UE), a user device, a user terminal, a mobile terminal, a mobile station, a mobile node, a subscriber device, a subscriber node, a subscriber terminal, or other user node. For example, a user node may be used for wireless communications with one or more network nodes (e.g., gNB, eNB, BS, AP, CU, DU, CU/DU) and/or with one or more other user nodes, regardless of the technology or radio access technology (RAT). In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network.

In addition, the techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC). Many of these new 5G (NR)-related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10⁻⁵ and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to an eMBB UE (or an eMBB application running on a UE).

The techniques described herein may be applied to a wide variety of wireless technologies or wireless networks, such as LTE, LTE-A, 5G (New Radio (NR)), cmWave, and/or mmWave band networks, 6G, IoT, MTC, eMTC, eMBB, URLLC, etc., or any other wireless network or wireless technology. These example networks, technologies or data service types are provided only as illustrative examples.

According to an example embodiment, a machine learning (ML) model may be used within a wireless network to perform (or assist with performing) one or more tasks. In general, one or more nodes (e.g., BS, gNB, eNB, RAN node, user node, UE, user device, relay node, or other wireless node) within a wireless network may use or employ a ML model, e.g., such as, for example a neural network model (e.g., which may be referred to as a neural network, an artificial intelligence (AI) neural network, an AI neural network model, an AI model, a machine learning (ML) model or algorithm, a model, or other term) to perform, or assist in performing, one or more ML-enabled tasks. Other types of models may also be used. A ML-enabled task may include tasks that may be performed (or assisted in performing) by a ML model, or a task for which a ML model has been trained to perform or assist in performing).

ML-based algorithms or ML models may be used to perform and/or assist with performing a variety of wireless and/or radio resource management (RRM) functions or tasks to improve network performance, such as, e.g., in the UE for antenna panel or beam control, RRM measurements and feedback (channel state information (CSI) feedback), link monitoring, Transmit Power Control (TPC), etc. In some cases, the use of ML models may be used to improve performance of a wireless network in one or more aspects or as measured by one or more performance indicators or performance criteria.

Models (e.g., neural networks or ML models) may be or may include, for example, computational models used in machine learning made up of nodes organized in layers. The nodes are also referred to as artificial neurons, or simply neurons, and perform a function on provided input to produce some output value. A neural network or ML model may typically require a training period to learn the parameters, i.e., weights, used to map the input to a desired output. The mapping occurs via the function. Thus, the weights are weights for the mapping function of the neural network. Each neural network model or ML model may be trained for a particular task.

To provide the output given the input, the neural network model or ML model should be trained, which may involve learning the proper value for a large number of parameters (e.g., weights) for the mapping function. The parameters are also commonly referred to as weights as they are used to weight terms in the mapping function. This training may be an iterative process, with the values of the weights being tweaked over many (e.g., thousands) of rounds of training until arriving at the optimal, or most accurate, values (or weights). In the context of neural networks (neural network models) or ML models, the parameters may be initialized, often with random values, and a training optimizer iteratively updates the parameters (weights) of the neural network to minimize error in the mapping function. In other words, during each round, or step, of iterative training the network updates the values of the parameters so that the values of the parameters eventually converge on the optimal values.

Neural network models or ML models may be trained in either a supervised or unsupervised manner, as examples. In supervised learning, training examples are provided to the neural network model or other machine learning algorithm. A training example includes the inputs and a desired or previously observed output. Training examples are also referred to as labeled data because the input is labeled with the desired or observed output. In the case of a neural network, the network learns the values for the weights used in the mapping function that most often result in the desired output when given the training inputs. In unsupervised training, the neural network model learns to identify a structure or pattern in the provided input. In other words, the model identifies implicit relationships in the data. Unsupervised learning is used in many machine learning problems and typically requires a large set of unlabeled data.

According to an example embodiment, the learning or training of a neural network model or ML model may be classified into (or may include) two broad categories (supervised and unsupervised), depending on whether there is a learning “signal” or “feedback” available to a model. Thus, for example, within the field of machine learning, there may be two main types of learning or training of a model: supervised, and unsupervised. The main difference between the two types is that supervised learning is done using known or prior knowledge of what the output values for certain samples of data should be. Therefore, a goal of supervised learning may be to learn a function that, given a sample of data and desired outputs, best approximates the relationship between input and output observable in the data. Unsupervised learning, on the other hand, does not have labeled outputs, so its goal is to infer the natural structure present within a set of data points.

Supervised learning: The computer is presented with example inputs and their desired outputs, and the goal may be to learn a general rule that maps inputs to outputs. Supervised learning may, for example, be performed in the context of classification, where a computer or learning algorithm attempts to map input to output labels, or regression, where the computer or algorithm may map input(s) to a continuous output(s). Common algorithms in supervised learning may include, e.g., logistic regression, naive Bayes, support vector machines, artificial neural networks, and random forests. In both regression and classification, a goal may include to find specific relationships or structure in the input data that allow us to effectively produce correct output data. As special cases, the input signal can be only partially available, or restricted to special feedback: Semi-supervised learning: the computer is given only an incomplete training signal: a training set with some (often many) of the target outputs missing. Active learning: the computer can only obtain training labels for a limited set of instances (based on a budget), and also may optimize its choice of objects to acquire labels for. When used interactively, these can be presented to the user for labeling. Reinforcement learning: training data (in form of rewards and punishments) is given only as feedback to the program's actions in a dynamic environment, e.g., using live data.

Unsupervised learning: No labels are given to the learning algorithm, leaving it on its own to find structure in its input. Some example tasks within unsupervised learning may include clustering, representation learning, and density estimation. In these cases, the computer or learning algorithm is attempting to learn the inherent structure of the data without using explicitly-provided labels. Some common algorithms include k-means clustering, principal component analysis, and auto-encoders. Since no labels are provided, there may be no specific way to compare model performance in most unsupervised learning methods.

It may be advantageous to provide techniques that may enable use of ML models, coordinate use of ML models, allow configuration of ML models, allow modification or training of a ML model, and/or facilitate distribution or communication of ML models or ML-assisted functionalities across wireless networks, e.g., between gNBs or RAN nodes and UEs, for various wireless-network related tasks. Some example tasks that a ML model may be used for may include, e.g., channel state information (CSI) feedback enhancement, e.g., overhead reduction, improved accuracy, prediction; beam management, e.g., beam prediction in time, and/or spatial domain for overhead and latency reduction, beam selection accuracy improvement; and/or UE positioning accuracy enhancements for different scenarios including, e.g., those with heavy NLOS (non-line of sight) conditions. These are just a few examples, and ML models may be applied or used to perform or assist in performing a wide variety of tasks within a wireless network.

In general, meta-learning may include or may refer to modifying, training, or tailoring a generic model (e.g., which may have been trained using features or data extracted from heterogeneous sources or from different UEs or different wireless nodes) to a specific type of entity and/or for a specific task. For example, meta-learning may include the process of setting the knobs (or parameters that may be adjusted) of learning procedures and/or the process or modifying weights or training of a model for a specific task. Also, meta-learning may include a case where a ML model is trained for a general (or more general) task, and then this trained ML model (that has been trained for the general task) is then (partially, possibly using transfer learning) trained or re-trained for a specific sub-task. Also, in some cases, meta-learning may include where machine learning algorithms themselves propose their own task distributions and/or where the process of setting the knobs (e.g., adjusting weights or making other modifications or training) of learning procedures via optimization. Algorithms that perform this optimization and/or training of a ML model automatically may be referred to as meta-learning algorithms. Meta-learning algorithms may consider data and/or algorithms over many tasks. In wireless communications, meta-learning (e.g., which may include modifying or training of a ML model for a specific task) may be used to develop, modify and/or train ML models for a variety of use cases or applications, such as, e.g., radio resource management and/or receiver design (as illustrative examples).

Various example embodiments are described, e.g., in which a model (e.g., ML model) is trained for a first task (e.g., a generic task), is communicated or transmitted from a first wireless node to a second wireless node, and then the ML model may be modified, trained or tailored by the second wireless node for a second task (e.g., a sub-task, which may be a task that is different than the generic task, but may be related in some aspect to the generic task, for example, such as where the sub-task may be in the same category of tasks as the sub-task, e.g., both the generic task and sub-task may be positioning-related, or both generic task and sub-task may be CSI-RS measurement-related).

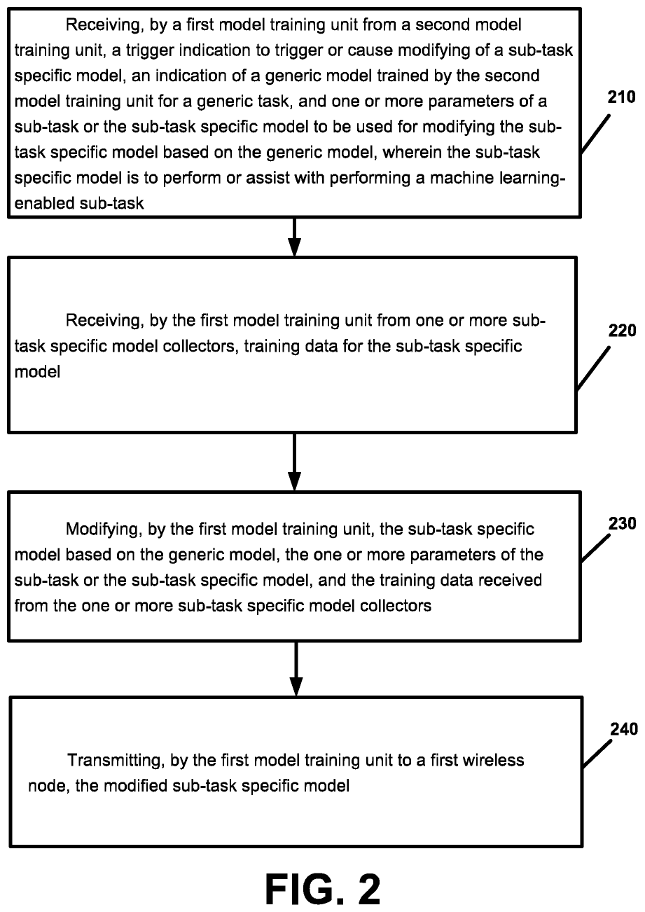

FIG. 2 is a flow chart illustrating operation of a model training unit according to an example embodiment. Operation 210 includes receiving, by a first model training unit (e.g., a meta-learning model training unit or a specific model training unit) from a second model training unit (e.g., a generic model training unit) a trigger indication to trigger or cause modifying (e.g., training) of a sub-task specific model, an indication of a generic model trained by the second model training unit for a generic task, and one or more parameters of a sub-task or the sub-task specific model to be used for modifying (e.g., training) the sub-task specific model based on the generic model, wherein the sub-task specific model is to perform or assist with performing a machine learning-enabled sub-task. Operation 220 includes receiving, by the first model training unit from one or more sub-task specific model collectors (e.g., UEs, gNBs or other wireless nodes) training data for the sub-task specific model. Operation 230 includes modifying (e.g., training or retraining, adjusting weights, configuring or updating, or other modification of the sub-task specific model), by the first model training unit, the sub-task specific model based on the generic model, the one or more parameters of the sub-task or the sub-task specific model, and the training data received from the one or more sub-task specific model collectors. And, operation 240 includes transmitting, by the first model training unit to a first wireless node (e.g., a UE or gNB), the modified (e.g., trained) sub-task specific model.

In an example embodiment of the method of FIG. 2, the modifying may include at least one of: modifying one or more weights of the sub-task specific model; training the sub-task specific model; re-training the sub-task specific model; configuring or updating one or more weights or parameters of the sub-task specific model; and/or upgrading (e.g., increasing the complexity, or increasing the numbers of inputs and/or outputs, or other upgrading) or downgrading (e.g., decreasing the complexity, decreasing the numbers of inputs and/or outputs, or other downgrading) the sub-task specific model.

According to an example embodiment of FIG. 2, the receiving a trigger indication may include: receiving, by the first model training unit from the second model training unit, one or more of the following: information of the generic model, including information of one or more of the following: an architecture of the generic model, weights of the generic model, a loss function and/or an activation function of the generic model, and/or a type of outputs of the generic model; sub-task parameterization including constraints of the sub-task specific model or a sub-task specific cost function of the sub-task specific model; and/or identifiers of the one or more sub-task specific model collectors.

According to an example embodiment of FIG. 2, the modifying, by the first model training unit, of the sub-task specific model may include performing one or more of the following based on the generic model and one or more constraints of the sub-task specific model: pruning, or reducing a size of, the generic model so that the sub-task specific model will fit within a maximum allowed sub-task specific model constraints; deactivating one or more inputs of the generic model so that inputs of the sub-task specific model depth or size will fit a format, size or depth of the training data received from the one or more sub-task specific model collectors; replacing a generic model activation function with a sub-task specific model-specific activation function; or defining a sub-task specific model-specific cost function.

According to an example embodiment of FIG. 2, the method may further include transmitting, by the first model training unit to the second model training unit, the modified sub-task specific model.

According to an example embodiment of FIG. 2, the method may further include transmitting, by the first model training unit to at least one of the one or more sub-task specific model collectors, the modified sub-task specific model.

According to an example embodiment of FIG. 2, wherein either: the first model training unit and the second model training unit are provided in a second wireless node; or the first model training unit is provided in a second wireless node and the second model training unit is provided in a third wireless node.

According to an example embodiment of FIG. 2, the method may further include transmitting, by the first model training unit to the second model training unit, a request for sub-task specific model training or meta-learning for the sub-task.

According to an example embodiment of FIG. 2: the second model training unit may include a generic model training unit configured to modify the generic model for a generic task; and the first model training unit may include a meta-learning model training unit or a specific model training unit that is configured to modify (e.g., train) a specific model or a sub-task specific model for the sub-task.

According to an example embodiment of FIG. 2, one or more of the first wireless node, the second wireless node or the third wireless node may include at least one of: a user equipment, a user device, a base station or a gNB.

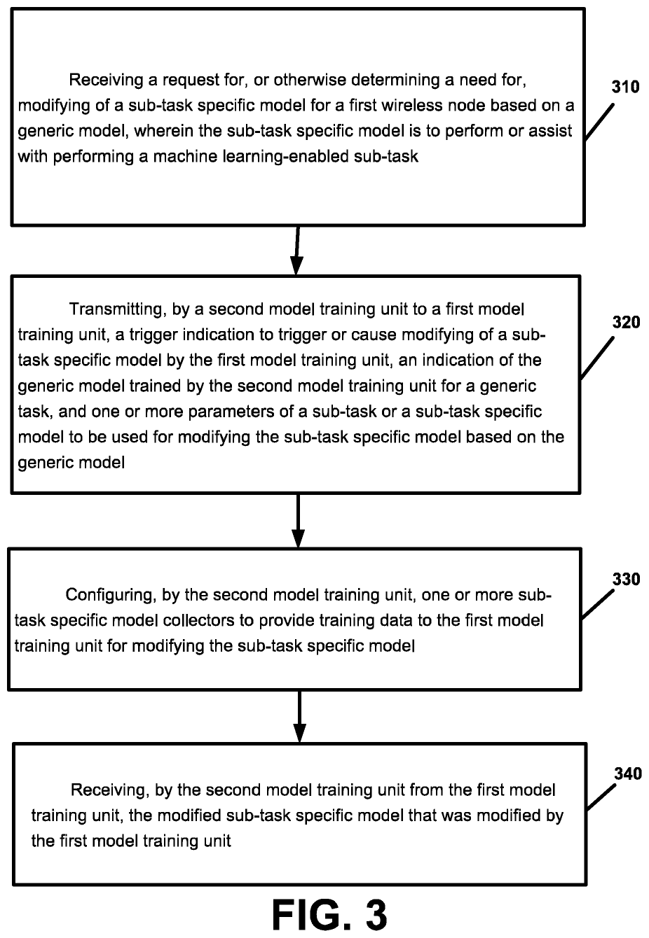

FIG. 3 is a flow chart illustrating operation of a second model training unit according to an example embodiment. Operation 310 includes receiving a request for, or otherwise determining a need for, modifying of a sub-task specific model for a first wireless node based on a generic model, wherein the sub-task specific model is to perform or assist with performing a machine learning-enabled sub-task. Operation 320 includes transmitting, by a second model training unit to a first model training unit, a trigger indication to trigger or cause modifying of a sub-task specific model by the first model training unit, an indication of the generic model trained by the second model training unit for a generic task, and one or more parameters of a sub-task or a sub-task specific model to be used for modifying the sub-task specific model based on the generic model. Operation 330 includes configuring, by the second model training unit, one or more sub-task specific model collectors to provide training data to the first model training unit for modifying the sub-task specific model. And, operation 340 includes receiving, by the second model training unit from the first model training unit, the modified sub-task specific model that was modified by the first model training unit.

According to an example embodiment of the method of FIG. 3, the transmitting may include transmitting, by the second model training unit to the first model training unit, one or more of the following: information of the generic model, including information of one or more of the following: an architecture of the generic model, weights of the generic model, a loss function and/or an activation function of the generic model, and/or a type of outputs of the generic model; sub-task parameterization including constraints of the sub-task specific model or a sub-task specific cost function of the sub-task specific model; and/or identifiers of the one or more sub-task specific model collectors.

According to an example embodiment of the method of FIG. 3, either: the first model training unit and the second model training unit are provided in a second wireless node; or the first model training unit is provided in a second wireless node and the second model training unit is provided in a third wireless node.

According to an example embodiment of the method of FIG. 3, the receiving a request for, or otherwise determining a need for, modifying of a sub-task specific model may include: receiving, by the second model training unit from the first model training unit, a request for modifying or training the sub-task specific model for the sub-task; and verifying the request for modifying or training the sub-task specific model for the sub-task.

According to an example embodiment of the method of FIG. 3, the second model training unit may include a generic model training unit configured to modify or train the generic model for a generic task; and the first model training unit may include a meta-learning model training unit or a specific model training unit that is configured to modify or train a specific model or a sub-task specific model for the sub-task.

According to an example embodiment of the method of FIG. 3, wherein one or more of the first wireless node, the second wireless node or the third wireless node comprises at least one of: a user equipment, a user device, a base station or a gNB.

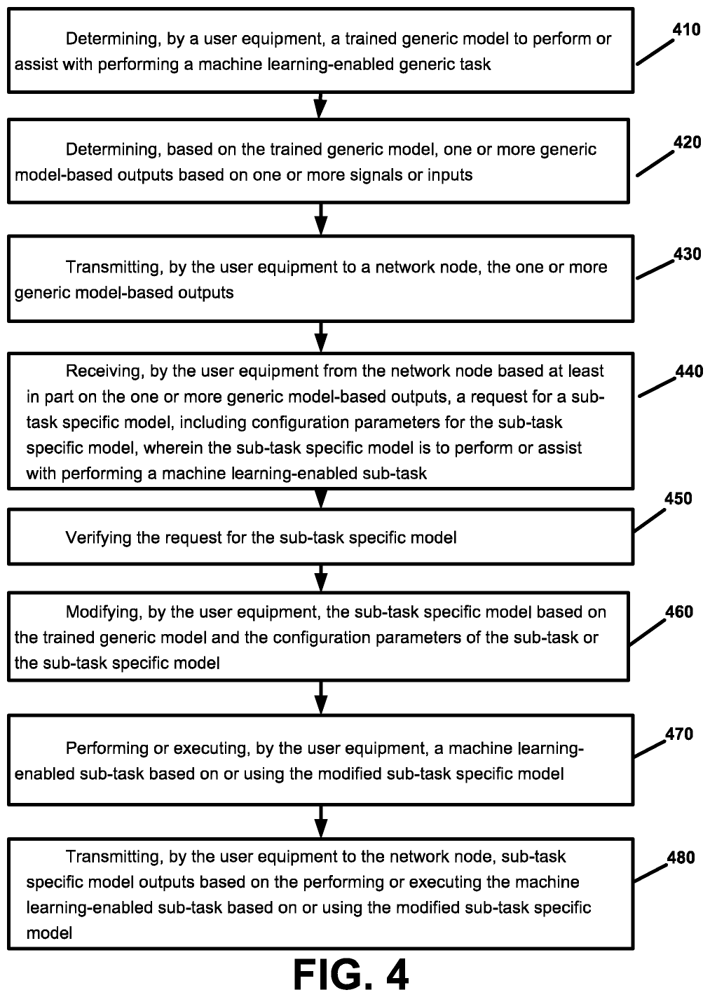

FIG. 4 is a flow chart illustrating operation of a user equipment according to an example embodiment. Operation 410 includes determining, by a user equipment (e.g., UE or user device), a trained generic model to perform or assist with performing a machine learning-enabled generic task. Operation 420 includes determining, based on the trained generic model, one or more generic model-based outputs based on one or more signals or inputs. Operation 430 includes transmitting, by the user equipment to a network node (e.g., a gNB), the one or more generic model-based outputs. Operation 440 includes receiving, by the user equipment from the network node based at least in part on the one or more generic model-based outputs, a request for a sub-task specific model, including configuration parameters for the sub-task specific model, wherein the sub-task specific model is to perform or assist with performing a machine learning-enabled sub-task. Operation 450 includes verifying the request for the sub-task specific model. Operation 460 includes modifying, by the user equipment, the sub-task specific model based on the trained generic model and the configuration parameters of the sub-task or the sub-task specific model. Operation 470 includes performing or executing, by the user equipment, a machine learning-enabled sub-task based on or using the modified sub-task specific model. And, operation 480 includes transmitting, by the user equipment to the network node, sub-task specific model outputs based on the performing or executing the machine learning-enabled sub-task based on or using the modified sub-task specific model.

According to an example embodiment of the method of FIG. 4, the modifying may include at least one of: modifying one or more weights of the sub-task specific model; training the sub-task specific model; re-training the sub-task specific model; configuring or updating one or more weights or parameters of the sub-task specific model; and/or upgrading or downgrading the sub-task specific model.

According to an example embodiment of the method of FIG. 4, the verifying the request for the sub-task specific model may include: verifying at least one of the following for the sub-task specific model: the requested sub-task specific model is on a list of permitted sub-task specific models; a threshold amount of training data and/or input signals are available for training the sub-task specific model; and/or a threshold amount of processor resources and/or memory resources are available for training and/or using of the sub-task specific model.

According to an example embodiment of the method of FIG. 4, the receiving a request for a sub-task specific model, including configuration parameters for the sub-task specific model may include receiving: a trigger indication to trigger or cause sub-task specific model meta-learning or training, and one or more parameters of a sub-task or a sub-task specific model to be used for training the sub-task specific model based on the generic model, including receiving sub-task parameterization including constraints of the sub-task specific model or a sub-task specific cost function of the sub-task specific model.

According to an example embodiment of the method of FIG. 4, the configuration parameters of the sub-task or the sub-task specific model may include one or more constraints of the sub-task specific model, and wherein the modifying, by the user equipment, of the sub-task specific model based on the generic model may include performing one or more of the following based on the generic model and one or more constraints of the sub-task specific model: pruning, or reducing a size of, the generic model so that the sub-task specific model will fit within a maximum allowed sub-task specific model depth or size; deactivating one or more inputs of the generic model so that inputs of the sub-task specific model depth or size will fit a format, size or depth of the training data received from the one or more sub-task specific model collectors; replace a generic model activation function with a sub-task specific model-specific activation function; or define a sub-task specific model-specific cost function.

According to an example embodiment of the method of FIG. 4, the determining one or more generic model-based outputs may include: receiving, by the user equipment from a network node, a request to train a generic model for the machine learning-enabled generic task; training, by the user equipment, the generic model based on a configuration or inputs received from the network node; and performing or executing the machine learning-enabled generic task using the trained generic model to obtain the one or more generic model-based outputs.

According to an example embodiment of the method of FIG. 4, the request for a sub-task specific model is received by the user equipment in response to transmitting, by the user equipment to the network node, the one or more generic model-based outputs of the trained generic model.

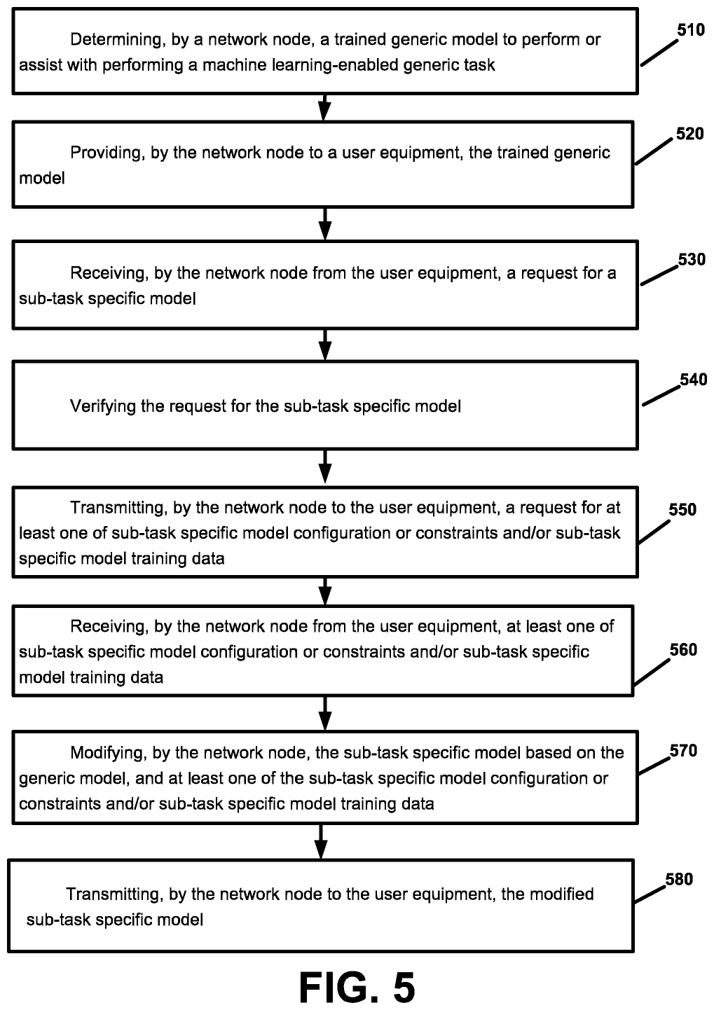

FIG. 5 is a flow chart illustrating operation of a network node (e.g., gNB) according to an example embodiment. Operation 510 includes determining, by a network node, a trained generic model to perform or assist with performing a machine learning-enabled generic task. Operation 520 includes providing, by the network node to a user equipment (e.g., UE or user device), the trained generic model. Operation 530 includes receiving, by the network node from the user equipment, a request for a sub-task specific model. Operation 540 includes verifying the request for the sub-task specific model. Operation 550 includes transmitting, by the network node to the user equipment, a request for at least one of sub-task specific model configuration or constraints and/or sub-task specific model training data. Operation 560 includes receiving, by the network node from the user equipment, at least one of sub-task specific model configuration or constraints and/or sub-task specific model training data. Operation 570 includes modifying, by the network node, the sub-task specific model based on the generic model, and at least one of the sub-task specific model configuration or constraints and/or sub-task specific model training data. And, operation 580 includes transmitting, by the network node to the user equipment, the modified sub-task specific model.

According to an example embodiment of the method of FIG. 5, the modifying may include at least one of: modifying one or more weights of the sub-task specific model; training the sub-task specific model; re-training the sub-task specific model; configuring or updating one or more weights or parameters of the sub-task specific model; and/or upgrading or downgrading the sub-task specific model.

According to an example embodiment of the method of FIG. 5, the verifying the request for the sub-task specific model may include: verifying at least one of the following for the sub-task specific model: the requested sub-task specific model is on a list of permitted sub-task specific models; a threshold amount of training data and/or input signals are available for training the sub-task specific model; and/or a threshold amount of processor resources and/or memory resources are available for training and/or using of the sub-task specific model.

According to an example embodiment of the method of FIG. 5, the modifying, by the network node, of the sub-task specific model may include performing one or more of the following based on the generic model and one or more constraints of the sub-task specific model: pruning, or reducing a size of, the generic model so that the sub-task specific model will fit within a maximum allowed sub-task specific model depth or size; deactivating one or more inputs of the generic model so that inputs of the sub-task specific model depth or size will fit a format, size or depth of the training data received from the one or more sub-task specific model collectors; replacing a generic model activation function with a sub-task specific model-specific activation function; or defining a sub-task specific model-specific cost function.

According to an example embodiment, techniques are provided that employ meta-learning (e.g., such as modifying or training) of a ML model for a ML-enabled function(s) or task(s), such as for radio resource management (RRM) related tasks for a wireless network. A framework is described for meta-learning of ML-enabled (RRM) functionalities. The framework may include and/or describe one or more operations and/or steps that may be used to port (i.e., generate and signal or transmit) a generic ML model to another wireless node, and then use meta-learning (e.g., training and/or modifying) of the generic ML model (that was trained for a generic task) to a sub-task specific model that is trained to perform or assist in performing a specific sub-task. New training data may be received and used to modify or train the sub-task specific model (e.g., to develop the sub-task specific model based on the generic ML model and the new training data or sub-task specific training data). Various example embodiments may provide or describe radio domain specific methods for: i) modifying and/or training (e.g., tuning/refining) a (e.g., generic) ML model (that may have been trained to perform a generic task or a first task) into a sub-task specific model(s) (that may be trained to perform a second task or a specific sub-task, that may be different from the generic task or first task), and ii) the related signalling between the involved network nodes.

The described framework, messages or signaling may enable the identification, communication and implementation of a breakdown of a generic task into sub-tasks, and/or the modification and/or training of a generic model to create a sub-task specific model that may be used to perform a specific sub-task.

### Example Definitions

Def. 1: A sub-task specific model (SSM) may include or may be defined as either:
   1) A model solving the same task as the generic model but implemented by a NR (new radio) element (e.g., a wireless node) of a different type (compared to the NR element which has been used to train the generic model). In one embodiment, the training data for the generic model does not include training observations collected from the specific element type (e.g., for the specific type of wireless node). For example, a generic task may be that of UL (uplink) power control parameter optimization for UEs in general, while the sub-task may be the tunning of the UL power control to different UE mobility classes (or to a specific UE mobility class) (e.g., pedestrian UE vs. vehicular UE, as identified by another algorithm). Thus, for example, a sub-task may be same or similar to the generic task, but may be applied to or the sub-task specific model may be applied to wireless nodes of a different type (as compared to the generic task or the generic ML model). Thus, for example, the generic task may be UL power control parameter optimization for UEs generally, while the specific sub-task (for which the sub-task specific model is trained) is UL power control for a specific class (or sub-class) of UEs, e.g., pedestrian UEs, vehicular UEs, airborne UEs. In another example, a generic task for UE energy saving might be performed by a NR UE and the sub-task might be UE energy saving performed in a reduced capability (RedCap) UE. Or,
   2) A model solving a similar (but different) task as the generic model (thus the sub-task is similar to the generic task, but different in at least one respect). Thus, for example, a sub-task may be different than the generic (or general) task, but may be related to the generic task, e.g., the sub-task may be in the same category of tasks (e.g., UL power control) as the generic (or general) task, (e.g., where, for example, the generic task may be for a general task, and the sub-task is for a different task that is in the same category of tasks (e.g., UL power control) as the generic task; And/or the sub-task may be for or applied to a subset (or to a different set) of conditions or devices as compared to the generic task. For example, a generic task may be best beam selection for UEs, while the similar (but different in at least one respect) sub-task may be best panel (or best antenna) selection. Also, in some cases, the sub-task specific model may for example, be implemented by an NR element of another/specific type (or by a NR element of a different type) (compared to the NR element which has been used to train the generic model).
Def. 2: Generic model training unit (GMTU) is a network (NW) node-residing entity or a UE-residing entity that trains a model for solving a generic task (e.g., a generic radio resource management (RRM) task). Thus, the GMTU is the ML model training unit that trains the generic model to solve or perform a generic task.
Def. 3: Meta-learning model training unit (MMTU) is a NW (network) node-residing entity or UE-residing entity that trains a model for solving a sub-task. Thus, a MMTU trains the sub-task specific model; MMTU and GMTU may be in different entities (e.g., UEs or network nodes) or provided within a same entity (e.g., within the same network node or UE). They may require or use (or rely on) processing and data collection sources. MMTU may be configured by GMTU, and wherein the GMTU may transfer the GM (generic model) and SSM (sub-task specific model) characteristics to the MMTU, and both MMTU and GMTU may reside in the same NR element, or within different NR elements. For example, GMTU-MMTU interfaces may be either Xn, F1, when both reside at the NW side, or RRC/MAC when one of them resides in the NR UE.
Def. 4: To train a sub-task specific model, MMTU may require assistance from other NR elements (residing at the UE side and/or NW side) called SSM (sub-task specific model)-collectors, which collect and then provide additional (or new or sub-task specific) training data to refine the model for a specific sub task). MMTU may interact with SSM collectors directly or indirectly, via the GMTU. The interaction has the role of refining a sub-task model. For example: MMTU may receive training data from the SSM collectors (e.g., UEs or other wireless nodes) that are activated by the GMTU/MMTU to collect and provide training data. MMTU then trains the new sub-task specific model. MMTU may first receive constraints of the SSM collectors related to data acquisition and pre-processing (sampling resolution, periodicity of feature extraction and reporting, etc.), or model constraints related to the size of the trained SSM that the SSM collector can deploy (after MMTU has trained it). Note that the MMTU and the SSM collector may reside in the same NR element e.g., a NR UE may be in charge of (or may perform) both collecting training data and training the SSM (sub-task specific model). When the MMTU and SSM collector are not collocated, their cooperation may be realized over Xn/F1 (e.g., when both are NW elements or different wireless nodes), or may use a RRC (radio resource control)/MAC (media access control) interface if MMTU and SSM collector are collocated (located within same wireless node, e.g., within same UE or same network node).

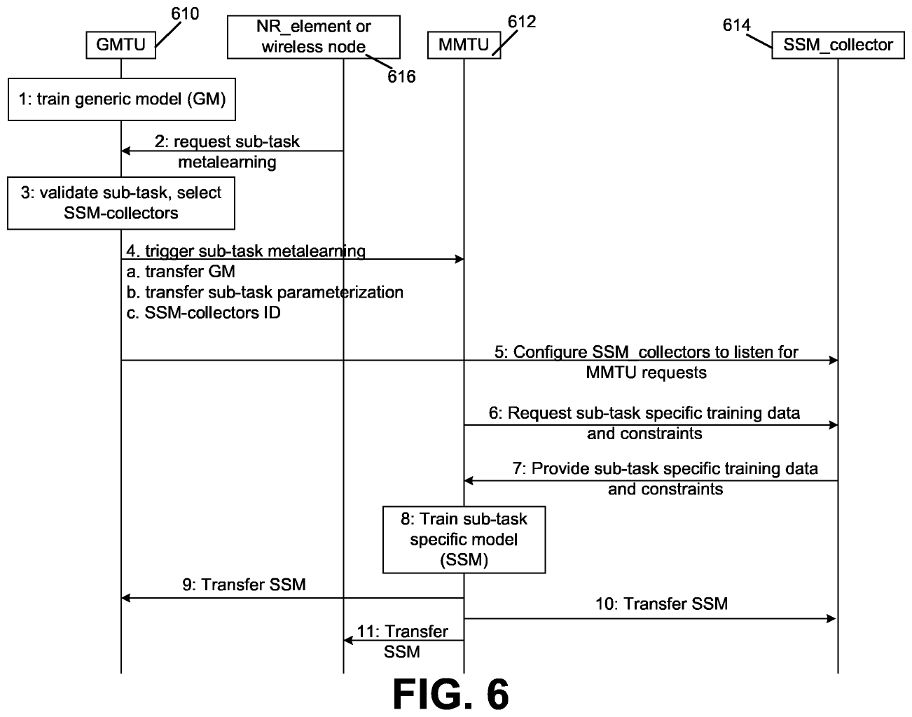

FIG. 6 is a diagram illustrating operation of a generic model training unit (GMTU) 610 and a meta-learning model training unit (MMTU) 612 or specific model training unit according to an example embodiment. The GMTU and MMTU may be provided within the same wireless node (e.g., collocated within a UE or network node), or may be provided within different wireless nodes. A new radio element 616 (NR element, or wireless node, which may be a UE or network node, for example) and a SSM collector 614 are also shown in the network of FIG. 6.

At step 1 of FIG. 6, GMTU 610 collects features from different NR element types (different types of UEs, or devices that may use the model being trained, e.g., UEs, TRP (transmission reception point), RSU roadside unit and trains a generic model (GM) for a given RRM task (e.g., for a generic task). GMTU 610 may maintain a list of RRM sub-tasks which are candidates for meta learning (for which a sub-task specific ML model may be trained).

At step 2 of FIG. 6, the modification or learning/refinement of sub-task specific model (SSM) may be triggered either: 1) On-demand/reactively by a (set of one or more) NR elements, e.g., if performance degradation is observed at such NR element. Or, 2) Periodically and/or proactively by the GMTU 610 or MMTU 612. The request may also contain or include a reason for SSM training or refinement. For example, a gNB may have a generic model for computing AoA (angle of arrival, to be used for UE positioning), and the UE would like to use a sub-task specific model for determining ToA (time of arrival, to be used for UE positioning). Thus, the sub-task (e.g., such as determining ToA) and generic task (e.g., such as determining AoA) may be similar, e.g., as they may be in a same category of tasks (e.g., category of positioning or determining arrival information for positioning), but the sub-task is slightly different than generic task (ToA as compared to AoA, in this example).

At step 3 of FIG. 6, GMTU validates/verifies the SSM learning request (e.g., but does not necessarily verify or validate the SSM model itself). For example, the verifying the request for the sub-task specific model (or request for meta-learning or training of the sub-task specific model) may include, e.g., verifying at least one of the following for the sub-task specific model: the requested sub-task specific model is on a list of permitted sub-task specific models; a threshold amount of training data and/or input signals are available for training the sub-task specific model; and/or a threshold amount of processor resources and/or memory resources are available for training and/or using of the sub-task specific model. Also, for example, to verify the SSM learning or training request, GMTU 610 may check the age (or date stamp compared to current day/time) of the latest SSM, the number, reason, and sources of SSM requests. Then, upon validation, GMTU 610 may select a host MMTU 612 (meta-learning model training unit, to modify or train the sub-task specific model) to manage model tuning, modifying or training, and generates a list of NR elements (e.g., a list of UEs, network nodes or other wireless nodes) to act as SSM collectors. Each NR element that serves as SSM collector may have (and/or may be identified by) a network identifier (ID). Using such ID, each SSM collector can be contacted by other network elements (e.g., contacted by MMTU 612). In one example, a network ID maybe an IP (Internet protocol) address and port number. SSM collectors may collect data as requested (e.g., for or related to a specific sub-task or for the sub-task specific model) and share the data generated on it and/or obtained from other sources via standardized (e.g., RRC, F1) and/or implementation-specific interfaces. If the validation/verification fails, the GMTU 610 indicates to the requesting node that the SSM cannot be generated.

At step 4 of FIG. 6, GMTU 610 triggers the sub-task specific model tuning, modifying or training at the MMTU 612. The trigger message may include for example: trained generic model (architecture of the model—e.g., weights of neural network, loss function, activation function, type of outputs the GM generates; and sub-task parameterization—additional constraints—activation function for subtask may be different and inputs may be different (e.g., only a subset of the inputs of GM may be available, might need new labels for the training data). The trigger message may include: the indication/identification of the trained generic model (GM), the sub-task specific parameterization, e.g. additional model constraints and sub-task specific cost function, and/or the SSM collectors IDs. For example, the MMTU 612 may receive a trigger indication to trigger or cause the MMTU to modify or train a sub-task specific model. The trigger message may include the trigger indication, an indication of a generic model trained by the second model training unit for a generic task, and one or more parameters of a sub-task or the sub-task specific model to be used for modifying the sub-task specific model based on the generic model, wherein the sub-task specific model is to perform or assist with performing a machine learning-enabled sub-task.

Thus, for example, the modifying or training, by the first MMTU, of the sub-task specific model based on the generic model may include performing one or more of the following based on the generic model and one or more constraints of the sub-task specific model: pruning, or reducing a size of, the generic model so that the sub-task specific model will fit within a maximum allowed sub-task specific model constraints; deactivating one or more inputs of the generic model so that inputs of the sub-task specific model depth or size will fit a format, size or depth of the training data received from the one or more sub-task specific model collectors; replacing a generic model activation function with a sub-task specific model-specific activation function; or defining a sub-task specific model-specific cost function.

Also, for example, the modifying or training of the sub-task specific model at least one of: modifying one or more weights of the sub-task specific model; training the sub-task specific model; re-training the sub-task specific model; configuring or updating one or more weights or parameters of the sub-task specific model; and/or upgrading or downgrading the sub-task specific model

At step 5 of FIG. 6, GMTU 610 configures the SSM collectors 614 to listen for MMTU requests and to transfer any combination of: 1) Their training data. SSM collector may collect and send measurements or other training data to be used to be processed at MMTU to extract the input features, or to be processed by SSM collector and forwarded to MMTU, or maybe just send measurements to MMTU 612; this training data may allow MMTU 612 to train the sub-task specific model. The type of training data may be defined by the GMTU 610 and requested explicitly when needed by the GMTU 610 or MMTU 612. The type of training data may be defined by any combination of: Features definition; Features cleaning and normalization required processes; Data collection periodicity i.e., how often training data is acquired; and Reporting frequency i.e., how often training data is cleaned and transferred, etc. 2) ML model limitations e.g., maximum depth of a NN (neural network or ML model); and 3) Other SSM collector-specific constraints e.g., power limitation, mobility level, etc.

At step 6 of FIG. 6, MMTU 610 may send a request to SSM collectors 614 to activate the selected SSM collectors 614. The activation may include or may involve sending a request to start: 1) The transfer of training data at a time instance characterized by an offset with respect to the reception of the activation signal; and 2) The collection, cleaning and then transfer of training data.

At step 7 of FIG. 6, the SSM collectors 614 may reply with the contents requested in Step 5 to MMTU (including information as listed above).

At step 8 of FIG. 6, the sub-task specific models are refined, modified or trained by MMTU 612. During this step, the MMTU 612 uses the GM (generic model) and the SSM-associated constraints and initializes the SSM (sub-task specific model). For example, MMTU 612 may: Prune the GM model to fit with a maximum allowed SSM depth; Deactivate some/none of the inputs of the GM to fit with the training data format that the SSM collectors can provide; Replace the GM activation function with the SSM-specific activation function, e.g., change a regression problem solved by the GM to a classification problem that the SSM should solve; Define an SSM-specific cost function e.g., by constraining the initial function with SSM-specific constraints, etc.

At step 9 of FIG. 6, the sub-task specific model (SSM) may be transferred (e.g., transmitted or communicated) by MMTU 612 to the GMTU 610.

At step 10 of FIG. 6, SSM may be simultaneously or subsequently transferred to the sub-task specific model may be transferred to SSM collectors

At step 11 of FIG. 6, SSM may be transferred (transmitted or communicated) to NR elements 616 for use or inference, e.g., so the NR element (e.g., UE or gNB) may apply the sub-task specific model (SSM) to solve or perform, or assist in performing, the sub-task.

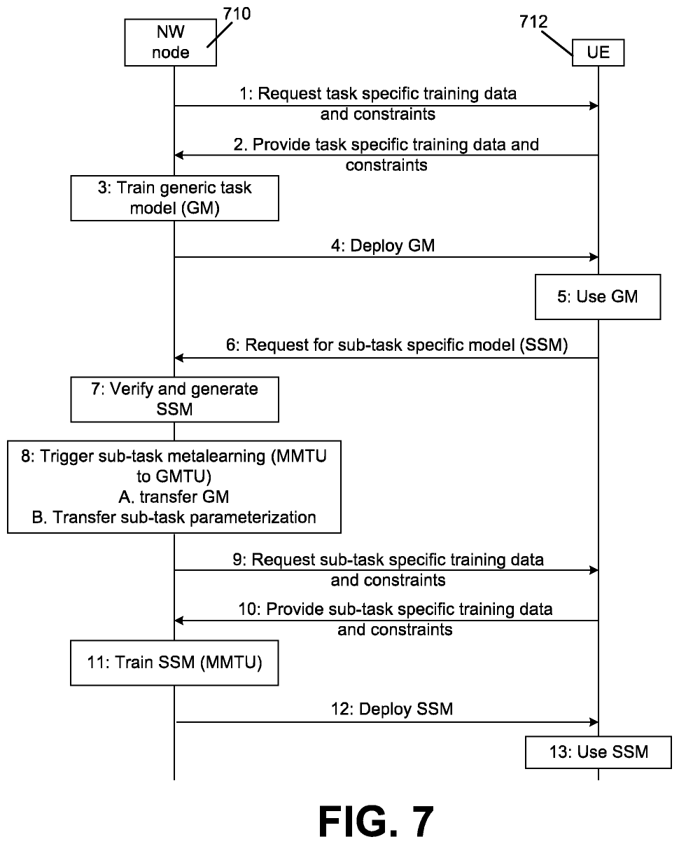

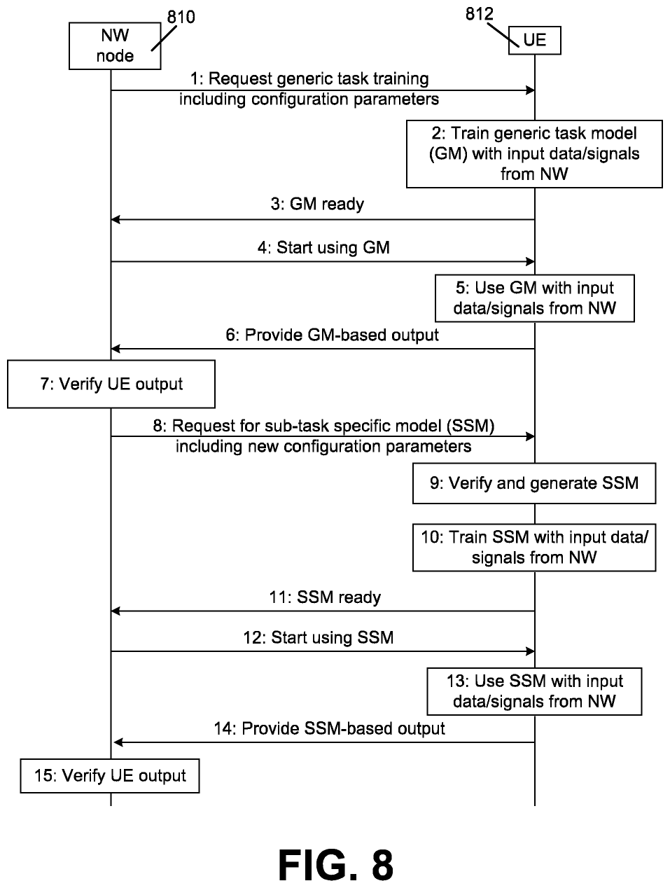

Based on the generic signalling flow in FIG. 6, FIGS. 7 and 8 are diagrams illustrating operation of a network in which: FIG. 7 is a diagram of a network in which generic model (GM) training and sub-task specific model (SSM) training are performed at a network node (e.g., gNB, AP, BS, core network node, CU and/or DU, RAN node, TRP (transmission reception point)); and, FIG. 8 is a diagram of a network in which generic model (GM) training and sub-task specific model (SSM) training are performed at a UE or user device.

FIG. 7 is a diagram of a network in which generic model (GM) training and sub-task specific model (SSM) training are performed at a network node (e.g., gNB, AP, BS, core network node, CU and/or DU, RAN node, TRP (transmission reception point)). Thus, for example, the GMTU and MMTU may both be present or provided within the network node 710 of FIG. 7. Referring to FIG. 7, a network node 710 may be in communication with a UE 712. Meta-learning or training/modifying of the sub-task specific model (e.g., based on the generic model, training data, and/or SSM constraints or parameters) may be performed by the network node 710. Thus, in FIG. 7, the network node 710 may manage the ML models (e.g., generic model and sub-task specific model), and wherein the models may be used, applied or implemented by the UE 712.

At step 1 of FIG. 7, when a new generic model needs to be deployed (or provided to a UE or other node for use), the network node 710 requests the corresponding training data from one or more (selected) UEs. Thus, at step 1 of FIG. 7, the network node 710 may send a request to UE 712 (and possibly to other UEs) for task specific training data and constraints.

At step 2 of FIG. 7, the UE 712 (which received the request at step 1) may provide the requested task specific training data and/or constraints to network node 710.

At step 3 of FIG. 7, the network node 710 modifies or trains the ML model, which may be a generic task model or generic model (GM) designed or trained to perform or solve a task, such as a generic task. Some explanation and examples have been provided above regarding a generic (or general) task model and sub-task specific model. For example, in general mathematical terms, a generic ML model (or generic task model) may find or obtain a solution x for a function f(x)=0, while a sub-task specific model finds a solution x, for a function g(x)=0, where there is a known relationship between functions g( ) and f( ) e.g.: g(x)=alpha*f(x)+(possibly one or more) constraints on the value of x. Also, for example, the sub-task specific model may have a set of inputs that are a subset of inputs used by the generic task model x, so g(x′). Similarly, for example, the sub-task specific model may have a set of outputs that are a subset of the outputs of the generic task model.

At step 4 of FIG. 7, the network node 710 deploys (e.g., transmits or communicated) the GM (generic model) to the selected UE(s), such as to UE 712.

At step 5 of FIG. 7, UE 712 uses the deployed GM (generic ML model) to perform or execute the ML-enabled task or function based on the GM. During the use or implementation of the GM, the UE 712 may identify or determine that an adaptation of the generic ML model would be beneficial or is required e.g., due to shifting input distribution, decreasing accuracy, decreasing performance, etc., or a need to apply this model to a slightly different (e.g., but related) task (e.g., to a sub-task). Note that for this capability, UE may need to get details about the context of the generic model, i.e., how the GM training dataset was generated, if the dataset was well balanced (e.g., the labels distribution). Alternatively, the network node may also detect the need for ML model adaptation in the UEs based on feedback (traditional or ML-related) from the UEs, e.g., a need for adaptation (re-training) of the generic model for performing a different task or a sub-task.

At step 6 of FIG. 7, if the UE has detected the need for ML adaptation (or re-training) of the generic model (e.g., to adapt or retrain the GM to perform a different task, e.g., a sub-task) in step 6, the UE 712 may generate and send a request to the network node 710 including the indication of the sub-task specific changes, or an indication of a requested sub-task specific model (SSM), or an indication or request to perform re-training/adaptation of the generic model to perform a new task or sub-task. Also, for example, when the need for a ML adaptation of generic model is determine or detected by the network node, e.g., a gNB, then this request (from the gNB) may still be needed in cases to indicate to the GMTU (within the network node 710, for FIG. 7) of the need for the sub-task specific model.

At step 7 of FIG. 7, the network node (e.g., a GMTU within the network node 710) may verify the request received in step 6 (e.g., verifies the request for the adaptation or retraining of the generic model to perform a different task or sub-task or the request for a sub-task specific model based on the generic model. This verification can be performed based on the provided sub-task description, an existing data base of possible sub-tasks, and/or the available compute power for such training tasks. Thus, for example, verifying the request for the sub-task specific model may include verifying at least one of the following for the sub-task specific model: the requested sub-task specific model is on a list of permitted sub-task specific models; at least a threshold amount of training data and/or input signals are available for training the sub-task specific model; and/or at least a threshold amount of processor resources and/or memory resources are available for training and/or using of the sub-task specific model.

At step 8 of FIG. 7, the network node may trigger (or cause) the generation of the sub-task specific model (SSM) and its required configuration parameters (training data type/source, etc.). The task to generate/train the SSM can be passed to the MMTU. Thus, at step 8 of FIG. 7, the network node 710 may trigger or cause a sub-task specific meta-learning or training of the sub-task specific model by MMTU, and a transfer (from GMTU to MMTU, within network node 710) of sub-task parameterization from, for example.

At step 9 of FIG. 7, the network node 710 (e.g., which may be or include one or both of GMTU and/or MMTU) may request SSM training data and/or constraints from the UE 712 (or from one or more UEs including UE 712). Note that SSM training data need not be the exactly same as GM training data, and can be a different set of data or a subset of the GM training data. For example, SSM training data could be a sub-task specific subset of GM training data, the SSM and GM training data may have different granularities, reporting frequencies, etc. Thus, for example, at step 9, the network node 710 may transmit to the UE 712 a request for at least one of: a sub-task specific model configuration or constraints and/or sub-task specific model training data.

At step 10 of FIG. 7, UE 712 may provide (or transmit to the network node 710) the training data specific to the SSM together with any UE-specific constraints (e.g., limitations on a size of a ML model that is supported by the UE, or certain features or capabilities (e.g., which may be related to ML models or RRM tasks for which a ML model may be used) that are supported or are not supported by the UE 712, or other constraints).

At step 11 of FIG. 7, the network node 710 (e.g., which may include the GMTU and/or MMTU) performs the training of the SSM, e.g., based on the generic model, the received sub-task specific training data, and/or any UE-specific constraints provided by the UE 712.

At step 12 of FIG. 7, the network node 710 may deploy (provide or transmit) the trained SSM model to the UE(s), including to UE 712.

At step 13 of FIG. 7, the UEs (e.g., including UE 712) use or apply the new SSM model to solve a problem or perform the sub-task.

As noted, FIG. 8 is a diagram of a network in which generic model (GM) training and sub-task specific model (SSM) training are performed at a UE or user device. In FIG. 8, a network node 810 may be in communication with a UE 812. In FIG. 8, the training of the generic model and sub-task specific model may be performed by the UE 812. The SSM may be trained or modified to perform a same task or a different task (e.g., sub-task) as the generic model was used for. Training of GM and/or SSM may be performed by the UE 812 (e.g., GMTU and/or MMTU provided within UE 812) and the training may be controlled and/or configured by the network node 810. Also, in the network of FIG. 8, the network node 810 may configure and/or test the ML-enabled function implemented in the UE 812 or performed by the SSM at the UE 812. The UE may perform the ML model training, e.g., without the network node 810 necessarily aware (and network node may or may not be aware) of the implementation specifics of SSM model in the UE 812. Also, according to an example embodiment, in FIG. 8, the GMTU may be provided in the network node 810, and the MMTU may be provided within the UE 812, for example.

At step 1 of FIG. 8, network node 812 may transmit a request the UE to train a model for the selected ML-enabled function (e.g., transmit a request to UE 812 to train a generic ML model for a generic task), including one or more configuration parameters. The network node does not need to indicate to the UE that this is a generic meta model, thus avoiding the possibility that the UE performs certain ‘tricks’ when generating the ML model.

At step 2 of FIG. 8, the UE 812 trains its ML model using input signals, data, configuration parameters, etc., provided by the network node 810, e.g., to generate the generic model to perform the generic task. The specifics of the required input signals/data and/or configuration parameters for the generic model can be provided by the network node 810. The UE 812 does not need to be aware that this model is treated as a generic model by the network node 810.

At step 3 of FIG. 8, the UE 812 sends an indication to the network node that the ML model is trained and ready for use to perform the generic task or solve a problem.

At step 4 of FIG. 8, the network node 810 triggers or causes the use or application of the generic model by UE 812, e.g., by network node 810 sending or transmitting a request to the UE 812 to use or apply the generic model. The required input signals/data may also be provided by network node 810 to the UE 812.

At step 5 of FIG. 8, the UE 812 uses or applied the generic trained ML model and executes the generic ML-enabled function using the provided input signals/data.

At step 6 of FIG. 8, UE 812 provides to network node 810 the configured feedback when using the ML-enabled function (GM-based). This step can happen periodically or in one-shot manner (once), depending on the ML-enabled function (generic task) under test. As part of this step, the UE 812 may provide or send to network node 810 generic model-based outputs (e.g., such as outputs of the generic trained model), so that the network node 810 may verify or confirm the outputs are correct and the generic model is performing well or as expected.

At step 7 of FIG. 8, the network node 810 verifies the UE output by comparing the provided feedback (e.g., generic model-based outputs provided by the UE) with expected feedback as generated with its own generic model (trained in the NW with same data and configuration, etc.). IF this step is declared as PASSED (the expected output matches the actual UE output/feedback), THEN the NW proceeds with Step 8 for a new sub-task specific test. ELSE (of this step is not declared as passed) the network node may proceed back to Step 1 for the same or a new task (potentially using different set of input conditions, parameters, etc.).

At step 8 of FIG. 8, the network node 810 may request the UE 812 to modify the ML model for sub-task specific use (e.g., to generate a sub-task specific model based on re-training of the generic mode). The network node 810 may provide the UE 812 with configuration parameters, sub-task description, etc.).

At step 9 of FIG. 8, the UE 812 verifies the request from the network node to modify the generic ML model for a particular sub-task (e.g., UE verifies the request to generate a sub-task specific model based on the trained generic model and other information provided by the network node 810). This verification can be performed based on the provided sub-task description, an existing data base of possible sub-tasks, and/or the available compute power for such training tasks.

Thus, the verifying may include, e.g., verifying at least one of the following for the sub-task specific model: the requested sub-task specific model is on a list of permitted sub-task specific models; a threshold amount of training data and/or input signals are available for training the sub-task specific model; and/or a threshold amount of processor resources and/or memory resources are available for training and/or using of the sub-task specific model.

At step 10 of FIG. 8, the UE 812 trains a SSM (sub-task specific model) with input signals/data from the network according to the received configuration (e.g., based on the trained generic model).

At step 11 of FIG. 8, the UE 812 indicates to the network node (GMTU) that the ML model (SSM) is trained and ready for use.

At step 12 of FIG. 8, the network node 810 sends a message or signal to the UE 812 to trigger or cause the UE 812 to use or apply the SSM to perform the sub-task.

At step 12 of FIG. 8, the UE 812 uses the sub-task specific ML model (SSM) and executes the ML-enabled function (to performs the sub-task) using the provided input signals/data.

At step 13 of FIG. 8, the UE 812 provides the configured feedback when using the ML-enabled function (SSM-based), e.g., UE 812 may provide SSM-based outputs (or outputs of the SSM) to the network node 810. This step 13 can happen periodically or once (or in a one-shot manner), depending on the ML-enabled function (e.g., sub-task) under test.

At step 14 of FIG. 8, the network node 810 verifies the UE output by comparing the provided feedback (E.g., SSM-based outputs) with expected feedback as generated with a its own SSM (trained in the NW with same data and configuration, etc.). IF this step is declared as PASSED (e.g., the provided feedback sufficiently matches within a threshold of the network node generated SSM-based outputs), then the network node 810 proceeds with Step 8 for a new sub-task specific test, OR with Step 1 for a new task. ELSE (of this step is not passed, e.g., feedback does not match the expected feedback) the network node 810 proceeds with Step 8 for the same sub-task (potentially using different set of input conditions).

Example use cases when NR element is UE:

The ML-based model, part of one or more UE ML-enabled functions, can be built to perform a generic task in the UEs. For example, the generic task is using a DNN (deep neural network)-based model to output category/labels and their probabilities, which then are used to trigger the action of UE beam selection.

For same task: The same task can be executed in two different (sets of) UEs which use different number of beams: The ML-based model is assumed to be initially trained based only one UE type with e.g., X=3 beams; or, alternatively, when only X beams out of Y beams are enabled for each UE during the training (the X beams can be selected by the UE or network node). The generic model training (including testing/validation etc) may occur or be performed in the network node or GMTU based on appropriate feedback/measurements from the selected UEs. The network node or GMTU deploys (or configures) the generic model to the UEs (e.g., sending the generic model configuration, constraints, or other parameters of the generic model to be trained by the UE). After receiving and using the generic model, certain UEs in the NW indicate the capability, or need, to use sub-task specific model (SSM) for the control of Z beams instead of X (Z<>X). The network node or GMTU initiates sub-task specific (UE-specific) training, or adjustments, of the generic model, for the corresponding UEs (other UE specific information can be additionally used if available at the NW). The sub-task specific model may be generated in MMTU or network node. The network node deploys (or configures) the specific models (SSMs) to the UEs which requested sub-task specific models.

For a similar (e.g., but slightly different task): A similar (e.g., but slightly different) task for the ML-based model may be (for example) to select antenna panels instead of antenna beams in the same or different UE(s): The ML-based model is assumed to be initially trained based only one UE type with e.g., X=3 beams. Or, alternatively, when only X beams out of Y beams are enabled for each UE during the training (the X beams can be selected by the UE or NW). The model training happens in the NW/GMTU based on appropriate feedback/measurements from the selected UEs. The network node or GMTU may deploy (or configure or transmit the model and configuration information) the generic model to the UEs. After receiving the generic model, certain UEs in the NW indicate the need to use ML-enabled antenna panel selection only instead of beam selection. The NW generates sub-task-specific (UE-specific) training, or adjustments, of the generic model, for the corresponding UEs (other UE specific information can be additionally used if available at the NW). The NW deploys (or configures) the specific models to the UEs which requested sub-task specific models.

From the illustrative examples above, the availability of the proposed mechanism for deploying the same ML-model for same task on different UEs (different number of beams) can be directly utilized in the conformance testing of the UE ML-enabled function of beam selection. The choice of and advantage of using meta-learning may be on the side of the network, for example. The diagram of FIG. 8 depicts some example signalling for this use case.

The conformance testing using the proposed approach could be extended also to the case when the ML model is not fully trained in the network node, but the training is at least partly configurable by the network node (e.g., which may be, for example, as a 3GPP pre-requisite for UE-gNB collaboration). The UE ML model may be trained in the UE using the exposed configuration parameters settings received form the network node and test signals provided by the network node. The generic task may be, for example, to use X=2 beams only (out of Y>X supported by the UE). After training and functionality verification for X=2, the network node may reconfigure (e.g., modify or retrain) the UE ML-enabled function (e.g., modify or re-train the generic model, to become or generate the SSM), requesting the use of Y>=Z>2 beams. As a response to this request the UE may indicate the need for more training, and test signals, from the NW. In this case, the choice of and advantage of using meta-learning is purely on the side of the UE. However, its use could be detected measuring the time it takes to adjust the generic/initial model for X beams to the new requirements of Z beams. In case additional ‘re-tuning time’ limits are imposed on the UE, then in order to comply, meta-learning would be more or less mandatory to implement in the UE. The diagram of FIG. 8 depicts examples of signalling that may be used for these types of UE conformance test use cases.

Example when NR element is gNB or network node:

An example for the case when the NR elements running ML-enabled function are gNBs may be where the UL (uplink) power control parameter optimization: either to determine the OLPC (open loop power control) P0 and/or alpha, and/or to determine the CLPC (closed loop power control) adjustments steps. With respect to FIG. 7, the following implementation may be used or may be possible: The GMTU/MMTU resides at the NW side. The NR element is a gNB. SSM collector is a selected cell-edge/cell-center UE.

OLPC may be an example use case. Typically, the OLPC (open loop power control, as a specific use function or sub-task for SSM model) parameters (P0 and alpha) are configured at cell level, e.g., the UEs served in cell may use the same values. However, the specification support per UE (UE specific) signalling of these parameters, thus more optimised approaches may also be used or performed. One such approach is to use UE clusters, based on their radio proximity (DL (downlink) RSRP (reference signal received power)) to the serving or neighbouring cells. In this case there may be at least two UE clusters (“cell-edge” and “cell-center”) with different set of OLPC parameters, and to be controlled separately by ML-enabled functions. With the meta-learning approach proposed described herein, a generic model can be trained with the aim to control both the OLPC P0 and/or alpha, using as inputs the radio measurements available from one or more cells (in a selected geo-area). The generic model may then be deployed to each gNB or network node, including potentially also to a network node or gNB from which no training data was used. During the operation, some of the network nodes or gNBs identify that a third UE cluster might be beneficial to control separately from the already included “cell-edge” and “cell-center” clusters e.g., a cluster of high speed UEs. These gNBs or network nodes may then request from the GMTU a sub-task specific model (e.g., for same task), and after the validation or verification of the request, the SSM may be trained (by the UE) and re-distributed or transmitted back to the corresponding network nodes or gNBs. The SSM can also be differentiated based on which OLPC is controlled (similar task). For example, a system may also include an identification algorithm to determine a need of a sub-task specific model and providing and/or collecting input training data.

Some further examples will be provided.
Example 1. A method may include: receiving, by a first model training unit from a second model training unit, a trigger indication to trigger or cause modifying of a sub-task specific model, an indication of a generic model trained by the second model training unit for a generic task, and one or more parameters of a sub-task or the sub-task specific model to be used for modifying the sub-task specific model based on the generic model, wherein the sub-task specific model is to perform or assist with performing a machine learning-enabled sub-task; receiving, by the first model training unit from one or more sub-task specific model collectors, training data for the sub-task specific model; modifying, by the first model training unit, the sub-task specific model based on the generic model, the one or more parameters of the sub-task or the sub-task specific model, and the training data received from the one or more sub-task specific model collectors; and transmitting, by the first model training unit to a first wireless node, the modified sub-task specific model.
Example 2. The method of example 1, wherein the modifying comprises at least one of: modifying one or more weights of the sub-task specific model; training the sub-task specific model; re-training the sub-task specific model; configuring or updating one or more weights or parameters of the sub-task specific model; and/or upgrading or downgrading the sub-task specific model.
Example 3. The method of any of examples 1-2, wherein the receiving a trigger indication comprises: receiving, by the first model training unit from the second model training unit, one or more of the following: information of the generic model, including information of one or more of the following: an architecture of the generic model, weights of the generic model, a loss function and/or an activation function of the generic model, and/or a type of outputs of the generic model; sub-task parameterization including constraints of the sub-task specific model or a sub-task specific cost function of the sub-task specific model; and/or identifiers of the one or more sub-task specific model collectors.
Example 4. The method of any of examples 1-3 wherein the modifying, by the first model training unit, of the sub-task specific model based on the generic model comprises performing one or more of the following based on the generic model and one or more constraints of the sub-task specific model: pruning, or reducing a size of, the generic model so that the sub-task specific model will fit within a maximum allowed sub-task specific model constraints; deactivating one or more inputs of the generic model so that inputs of the sub-task specific model depth or size will fit a format, size or depth of the training data received from the one or more sub-task specific model collectors; replacing a generic model activation function with a sub-task specific model-specific activation function; or defining a sub-task specific model-specific cost function.
Example 5. The method of any of examples 1-4, further comprising: transmitting, by the first model training unit to the second model training unit, the modified sub-task specific model.
Example 6. The method of any of examples 1-5, further comprising: transmitting, by the first model training unit to at least one of the one or more sub-task specific model collectors, the modified sub-task specific model.
Example 7. The method of any of examples 1-6, wherein either: the first model training unit and the second model training unit are provided in a second wireless node; or the first model training unit is provided in a second wireless node and the second model training unit is provided in a third wireless node.
Example 8. The method of any of examples 1-7, further comprising: transmitting, by the first model training unit to the second model training unit, a request for sub-task specific model training or meta-learning for the sub-task.
Example 9. The method of any of examples 1-8, wherein: the second model training unit comprises a generic model training unit configured to modify the generic model for a generic task; and the first model training unit is a meta-learning model training unit or a specific model training unit that is configured to modify a specific model or a sub-task specific model for the sub-task.
Example 10. The method of any of examples 1-8, wherein one or more of the first wireless node, the second wireless node or the third wireless node comprises at least one of: a user equipment, a user device, a base station or a gNB.
Example 11. An apparatus comprising: at least one processor; and at least one memory including computer program code; the at least one memory and the computer program code configured to, with the at least one processor, cause the apparatus at least to: receive, by a first model training unit from a second model training unit, a trigger indication to trigger or cause modifying of a sub-task specific model, an indication of a generic model trained by the second model training unit for a generic task, and one or more parameters of a sub-task or the sub-task specific model to be used for modifying the sub-task specific model based on the generic model, wherein the sub-task specific model is to perform or assist with performing a machine learning-enabled sub-task; receive, by the first model training unit from one or more sub-task specific model collectors, training data for the sub-task specific model; modify, by the first model training unit, the sub-task specific model based on the generic model, the one or more parameters of the sub-task or the sub-task specific model, and the training data received from the one or more sub-task specific model collectors; and transmit, by the first model training unit to a first wireless node, the modified sub-task specific model.
Example 12. An apparatus comprising: means for receiving, by a first model training unit from a second model training unit, a trigger indication to trigger or cause modifying of a sub-task specific model, an indication of a generic model trained by the second model training unit for a generic task, and one or more parameters of a sub-task or the sub-task specific model to be used for modifying the sub-task specific model based on the generic model, wherein the sub-task specific model is to perform or assist with performing a machine learning-enabled sub-task; means for receiving, by the first model training unit from one or more sub-task specific model collectors, training data for the sub-task specific model; means for modifying, by the first model training unit, the sub-task specific model based on the generic model, the one or more parameters of the sub-task or the sub-task specific model, and the training data received from the one or more sub-task specific model collectors; and means for transmitting, by the first model training unit to a first wireless node, the modified sub-task specific model.
Example 13. A non-transitory computer-readable storage medium comprising instructions stored thereon that, when executed by at least one processor, are configured to cause a computing system to: receive, by a first model training unit from a second model training unit, a trigger indication to trigger or cause modifying of a sub-task specific model, an indication of a generic model trained by the second model training unit for a generic task, and one or more parameters of a sub-task or the sub-task specific model to be used for modifying the sub-task specific model based on the generic model, wherein the sub-task specific model is to perform or assist with performing a machine learning-enabled sub-task; receive, by the first model training unit from one or more sub-task specific model collectors, training data for the sub-task specific model; modify, by the first model training unit, the sub-task specific model based on the generic model, the one or more parameters of the sub-task or the sub-task specific model, and the training data received from the one or more sub-task specific model collectors; and transmit, by the first model training unit to a first wireless node, the modified sub-task specific model.
Example 14. A method comprising: receiving a request for, or otherwise determining a need for, modifying of a sub-task specific model for a first wireless node based on a generic model, wherein the sub-task specific model is to perform or assist with performing a machine learning-enabled sub-task; transmitting, by a second model training unit to a first model training unit, a trigger indication to trigger or cause modifying of a sub-task specific model by the first model training unit, an indication of the generic model trained by the second model training unit for a generic task, and one or more parameters of a sub-task or a sub-task specific model to be used for modifying the sub-task specific model based on the generic model; configuring, by the second model training unit, one or more sub-task specific model collectors to provide training data to the first model training unit for modifying the sub-task specific model; and receiving, by the second model training unit from the first model training unit, the modified sub-task specific model that was modified by the first model training unit.
Example 15. The method of example 14, wherein the transmitting comprises: transmitting, by the second model training unit to the first model training unit, one or more of the following: information of the generic model, including information of one or more of the following: an architecture of the generic model, weights of the generic model, a loss function and/or an activation function of the generic model, and/or a type of outputs of the generic model; sub-task parameterization including constraints of the sub-task specific model or a sub-task specific cost function of the sub-task specific model; and/or identifiers of the one or more sub-task specific model collectors.
Example 16. The method of any of examples 14-15, wherein either: the first model training unit and the second model training unit are provided in a second wireless node; or the first model training unit is provided in a second wireless node and the second model training unit is provided in a third wireless node.
Example 17. The method of any of examples 14-16, wherein the receiving a request for, or otherwise determining a need for, modifying of a sub-task specific model comprises: receiving, by the second model training unit from the first model training unit, a request for modifying or training the sub-task specific model for the sub-task; and verifying the request for modifying or training the sub-task specific model for the sub-task.
Example 18. The method of any of examples 14-17, wherein: the second model training unit comprises a generic model training unit configured to modify or train the generic model for a generic task; and the first model training unit is a meta-learning model training unit or a specific model training unit that is configured to modify or train a specific model or a sub-task specific model for the sub-task.
Example 19. The method of any of examples 14-18, wherein one or more of the first wireless node, the second wireless node or the third wireless node comprises at least one of: a user equipment, a user device, a base station or a gNB.
Example 20. An apparatus comprising: at least one processor; and at least one memory including computer program code; the at least one memory and the computer program code configured to, with the at least one processor, cause the apparatus at least to: receive a request for, or otherwise determining a need for, modifying of a sub-task specific model for a first wireless node based on a generic model, wherein the sub-task specific model is to perform or assist with performing a machine learning-enabled sub-task; transmit, by a second model training unit to a first model training unit, a trigger indication to trigger or cause modifying of a sub-task specific model by the first model training unit, an indication of the generic model trained by the second model training unit for a generic task, and one or more parameters of a sub-task or a sub-task specific model to be used for modifying the sub-task specific model based on the generic model; configure, by the second model training unit, one or more sub-task specific model collectors to provide training data to the first model training unit for modifying the sub-task specific model; and receive, by the second model training unit from the first model training unit, the modified sub-task specific model that was modified by the first model training unit.
Example 21. An apparatus comprising: means for receiving a request for, or otherwise determining a need for, modifying of a sub-task specific model for a first wireless node based on a generic model, wherein the sub-task specific model is to perform or assist with performing a machine learning-enabled sub-task; means for transmitting, by a second model training unit to a first model training unit, a trigger indication to trigger or cause modifying of a sub-task specific model by the first model training unit, an indication of the generic model trained by the second model training unit for a generic task, and one or more parameters of a sub-task or a sub-task specific model to be used for modifying the sub-task specific model based on the generic model; means for configuring, by the second model training unit, one or more sub-task specific model collectors to provide training data to the first model training unit for modifying the sub-task specific model; and means for receiving, by the second model training unit from the first model training unit, the modified sub-task specific model that was modified by the first model training unit.
Example 22. A non-transitory computer-readable storage medium comprising instructions stored thereon that, when executed by at least one processor, are configured to cause a computing system to: receive a request for, or otherwise determining a need for, modifying of a sub-task specific model for a first wireless node based on a generic model, wherein the sub-task specific model is to perform or assist with performing a machine learning-enabled sub-task; transmit, by a second model training unit to a first model training unit, a trigger indication to trigger or cause modifying of a sub-task specific model by the first model training unit, an indication of the generic model trained by the second model training unit for a generic task, and one or more parameters of a sub-task or a sub-task specific model to be used for modifying the sub-task specific model based on the generic model; configure, by the second model training unit, one or more sub-task specific model collectors to provide training data to the first model training unit for modifying the sub-task specific model; and receive, by the second model training unit from the first model training unit, the modified sub-task specific model that was modified by the first model training unit.
Example 23. A method comprising: determining, by a user equipment, a trained generic model to perform or assist with performing a machine learning-enabled generic task; determining, based on the trained generic model, one or more generic model-based outputs based on one or more signals or inputs; transmitting, by the user equipment to a network node, the one or more generic model-based outputs; receiving, by the user equipment from the network node based at least in part on the one or more generic model-based outputs, a request for a sub-task specific model, including configuration parameters for the sub-task specific model, wherein the sub-task specific model is to perform or assist with performing a machine learning-enabled sub-task; verifying the request for the sub-task specific model; modifying, by the user equipment, the sub-task specific model based on the trained generic model and the configuration parameters of the sub-task or the sub-task specific model; and performing or executing, by the user equipment, a machine learning-enabled sub-task based on or using the modified sub-task specific model; and transmitting, by the user equipment to the network node, sub-task specific model outputs based on the performing or executing the machine learning-enabled sub-task based on or using the modified sub-task specific model.
Example 24. The method of example 23, wherein the modifying comprises at least one of: modifying one or more weights of the sub-task specific model; training the sub-task specific model; re-training the sub-task specific model; configuring or updating one or more weights or parameters of the sub-task specific model; and/or upgrading or downgrading the sub-task specific model.
Example 25. The method of any of examples 23-24, wherein the verifying the request for the sub-task specific model comprises: verifying at least one of the following for the sub-task specific model: the requested sub-task specific model is on a list of permitted sub-task specific models; a threshold amount of training data and/or input signals are available for training the sub-task specific model; and/or a threshold amount of processor resources and/or memory resources are available for training and/or using of the sub-task specific model.
Example 26. The method of any of examples 23-25, wherein the receiving a request for a sub-task specific model, including configuration parameters for the sub-task specific model comprises receiving: a trigger indication to trigger or cause sub-task specific model meta-learning or training, and one or more parameters of a sub-task or a sub-task specific model to be used for training the sub-task specific model based on the generic model, including receiving sub-task parameterization including constraints of the sub-task specific model or a sub-task specific cost function of the sub-task specific model.
Example 27. The method of any of examples 23-26, wherein the configuration parameters of the sub-task or the sub-task specific model comprise one or more constraints of the sub-task specific model, and wherein the modifying, by the user equipment, of the sub-task specific model based on the generic model comprises performing one or more of the following based on the generic model and one or more constraints of the sub-task specific model: pruning, or reducing a size of, the generic model so that the sub-task specific model will fit within a maximum allowed sub-task specific model depth or size; deactivating one or more inputs of the generic model so that inputs of the sub-task specific model depth or size will fit a format, size or depth of the training data received from the one or more sub-task specific model collectors; replacing a generic model activation function with a sub-task specific model-specific activation function; or defining a sub-task specific model-specific cost function.
Example 28. The method of any of examples 23-27, wherein the determining one or more generic model-based outputs comprises: receiving, by the user equipment from a network node, a request to train a generic model for the machine learning-enabled generic task; training, by the user equipment, the generic model based on a configuration or inputs received from the network node; and performing or executing the machine learning-enabled generic task using the trained generic model to obtain the one or more generic model-based outputs.
Example 29. The method of example 28, wherein the request for a sub-task specific model is received by the user equipment in response to transmitting, by the user equipment to the network node, the one or more generic model-based outputs of the trained generic model.
Example 30. An apparatus comprising: at least one processor; and at least one memory including computer program code; the at least one memory and the computer program code configured to, with the at least one processor, cause the apparatus at least to: determine, by a user equipment, a trained generic model for performing or assist with performing a generic machine learning-enabled task; determine, based on the trained generic model, one or more generic model-based outputs based on one or more signals or inputs; transmit, by the user equipment to a network node, the one or more generic model-based outputs; receive, by the user equipment from the network node based at least in part of the one or more generic model-based outputs, a request for a sub-task specific model, including configuration parameters for the sub-task specific model, wherein the sub-task specific model is to perform or assist with performing a machine learning-enabled sub-task; verify the request for the sub-task specific model; modify, by the user equipment, the sub-task specific model based on the trained generic model and the configuration parameters of the sub-task or the sub-task specific model; perform or execute, by the user equipment, a machine learning-enabled sub-task based on or using the modified sub-task specific model; and transmit, by the user equipment to the network node, sub-task specific model outputs based on the performing or executing the machine learning-enabled sub-task based on or using the trained sub-task specific model.
Example 31. An apparatus comprising: means for determining, by a user equipment, a trained generic model for performing or assist with performing a generic machine learning-enabled task; means for determining, based on the trained generic model, one or more generic model-based outputs based on one or more signals or inputs; means for transmitting, by the user equipment to a network node, the one or more generic model-based outputs; means for receiving, by the user equipment from the network node based at least in part of the one or more generic model-based outputs, a request for a sub-task specific model, including configuration parameters for the sub-task specific model, wherein the sub-task specific model is to perform or assist with performing a machine learning-enabled sub-task; means for verifying the request for the sub-task specific model; means for modifying, by the user equipment, the sub-task specific model based on the trained generic model and the configuration parameters of the sub-task or the sub-task specific model; and means for performing or executing, by the user equipment, a machine learning-enabled sub-task based on or using the modified sub-task specific model; and means for transmitting, by the user equipment to the network node, sub-task specific model outputs based on the performing or executing the machine learning-enabled sub-task based on or using the trained sub-task specific model.
Example 32. A non-transitory computer-readable storage medium comprising instructions stored thereon that, when executed by at least one processor, are configured to cause a computing system to: determine, by a user equipment, a trained generic model for performing or assist with performing a generic machine learning-enabled task; determine, based on the trained generic model, one or more generic model-based outputs based on one or more signals or inputs; transmit, by the user equipment to a network node, the one or more generic model-based outputs; receive, by the user equipment from the network node based at least in part of the one or more generic model-based outputs, a request for a sub-task specific model, including configuration parameters for the sub-task specific model, wherein the sub-task specific model is to perform or assist with performing a machine learning-enabled sub-task; verify the request for the sub-task specific model; modify, by the user equipment, the sub-task specific model based on the trained generic model and the configuration parameters of the sub-task or the sub-task specific model; perform or execute, by the user equipment, a machine learning-enabled sub-task based on or using the modified sub-task specific model; and transmit, by the user equipment to the network node, sub-task specific model outputs based on the performing or executing the machine learning-enabled sub-task based on or using the trained sub-task specific model.
Example 33. A method comprising: determining, by a network node, a trained generic model to perform or assist with performing a machine learning-enabled generic task; providing, by the network node to a user equipment, the trained generic model; receiving, by the network node from the user equipment, a request for a sub-task specific model; verifying the request for the sub-task specific model; transmitting, by the network node to the user equipment, a request for at least one of sub-task specific model configuration or constraints and/or sub-task specific model training data; receiving, by the network node from the user equipment, at least one of sub-task specific model configuration or constraints and/or sub-task specific model training data; modifying, by the network node, the sub-task specific model based on the generic model, and at least one of the sub-task specific model configuration or constraints and/or sub-task specific model training data; and transmitting, by the network node to the user equipment, the modified sub-task specific model.
Example 34. The method of example 33, wherein the modifying comprises at least one of: modifying one or more weights of the sub-task specific model; training the sub-task specific model; re-training the sub-task specific model; configuring or updating one or more weights or parameters of the sub-task specific model; and/or upgrading or downgrading the sub-task specific model.
Example 35. The method of any of examples 33-34, wherein the verifying the request for the sub-task specific model comprises: verifying at least one of the following for the sub-task specific model: the requested sub-task specific model is on a list of permitted sub-task specific models; a threshold amount of training data and/or input signals are available for training the sub-task specific model; and/or a threshold amount of processor resources and/or memory resources are available for training and/or using of the sub-task specific model.
Example 36. The method of any of examples 33-35, wherein the modifying, by the network node, of the sub-task specific model based on the generic model comprises performing one or more of the following based on the generic model and one or more constraints of the sub-task specific model: pruning, or reducing a size of, the generic model so that the sub-task specific model will fit within a maximum allowed sub-task specific model depth or size; deactivating one or more inputs of the generic model so that inputs of the sub-task specific model depth or size will fit a format, size or depth of the training data received from the one or more sub-task specific model collectors; replacing a generic model activation function with a sub-task specific model-specific activation function; or defining a sub-task specific model-specific cost function.
Example 37. An apparatus comprising: at least one processor; and at least one memory including computer program code; the at least one memory and the computer program code configured to, with the at least one processor, cause the apparatus at least to: determine, by a network node, a trained generic model to perform or assist with performing a machine learning-enabled generic task; provide, by the network node to a user equipment, the trained generic model; receive, by the network node from the user equipment, a request for a sub-task specific model; verify the request for the sub-task specific model; transmit, by the network node to the user equipment, a request for at least one of sub-task specific model configuration or constraints and/or sub-task specific model training data; receive, by the network node from the user equipment, at least one of sub-task specific model configuration or constraints and/or sub-task specific model training data; modify, by the network node, the sub-task specific model based on the generic model, and at least one of the sub-task specific model configuration or constraints and/or sub-task specific model training data; and transmit, by the network node to the user equipment, the modified sub-task specific model.
Example 38. An apparatus comprising: means for determining, by a network node, a trained generic model to perform or assist with performing a machine learning-enabled generic task; means for providing, by the network node to a user equipment, the trained generic model; means for receiving, by the network node from the user equipment, a request for a sub-task specific model; means for verifying the request for the sub-task specific model; means for transmitting, by the network node to the user equipment, a request for at least one of sub-task specific model configuration or constraints and/or sub-task specific model training data; means for receiving, by the network node from the user equipment, at least one of sub-task specific model configuration or constraints and/or sub-task specific model training data; means for modifying, by the network node, the sub-task specific model based on the generic model, and at least one of the sub-task specific model configuration or constraints and/or sub-task specific model training data; and means for transmitting, by the network node to the user equipment, the modified sub-task specific model.
Example 39. A non-transitory computer-readable storage medium comprising instructions stored thereon that, when executed by at least one processor, are configured to cause a computing system to: determine, by a network node, a trained generic model to perform or assist with performing a machine learning-enabled generic task; provide, by the network node to a user equipment, the trained generic model; receive, by the network node from the user equipment, a request for a sub-task specific model; verify the request for the sub-task specific model; transmit, by the network node to the user equipment, a request for at least one of sub-task specific model configuration or constraints and/or sub-task specific model training data; receive, by the network node from the user equipment, at least one of sub-task specific model configuration or constraints and/or sub-task specific model training data; modify, by the network node, the sub-task specific model based on the generic model, and at least one of the sub-task specific model configuration or constraints and/or sub-task specific model training data; and transmit, by the network node to the user equipment, the modified sub-task specific model.

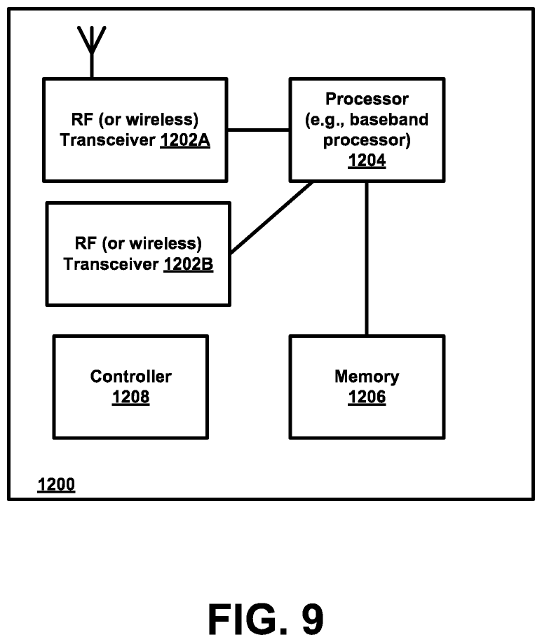

FIG. 9 is a block diagram of a wireless station or node (e.g., UE, user device, AP, BS, eNB, gNB, RAN node, network node, TRP, or other node) 1200 according to an example embodiment. The wireless station 1200 may include, for example, one or more (e.g., two as shown in FIG. 9) RF (radio frequency) or wireless transceivers 1202A, 1202B, where each wireless transceiver includes a transmitter to transmit signals and a receiver to receive signals. The wireless station also includes a processor or control unit/entity (controller) 1204 to execute instructions or software and control transmission and receptions of signals, and a memory 1206 to store data and/or instructions.

Processor 1204 may also make decisions or determinations, generate frames, packets or messages for transmission, decode received frames or messages for further processing, and other tasks or functions described herein. Processor 1204, which may be a baseband processor, for example, may generate messages, packets, frames or other signals for transmission via wireless transceiver 1202 (1202A or 1202B). Processor 1204 may control transmission of signals or messages over a wireless network, and may control the reception of signals or messages, etc., via a wireless network (e.g., after being down-converted by wireless transceiver 1202, for example). Processor 1204 may be programmable and capable of executing software or other instructions stored in memory or on other computer media to perform the various tasks and functions described above, such as one or more of the tasks or methods described above. Processor 1204 may be (or may include), for example, hardware, programmable logic, a programmable processor that executes software or firmware, and/or any combination of these. Using other terminology, processor 1204 and transceiver 1202 together may be considered as a wireless transmitter/receiver system, for example.

In addition, referring to FIG. 9, a controller (or processor) 1208 may execute software and instructions, and may provide overall control for the station 1200, and may provide control for other systems not shown in FIG. 9, such as controlling input/output devices (e.g., display, keypad), and/or may execute software for one or more applications that may be provided on wireless station 1200, such as, for example, an email program, audio/video applications, a word processor, a Voice over IP application, or other application or software.

In addition, a storage medium may be provided that includes stored instructions, which when executed by a controller or processor may result in the processor 1204, or other controller or processor, performing one or more of the functions or tasks described above.

According to another example embodiment, RF or wireless transceiver(s) 1202A/1202B may receive signals or data and/or transmit or send signals or data. Processor 1204 (and possibly transceivers 1202A/1202B) may control the RF or wireless transceiver 1202A or 1202B to receive, send, broadcast or transmit signals or data.

Embodiments of the various techniques described herein may be implemented in digital electronic circuitry, or in computer hardware, firmware, software, or in combinations of them. Embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer, or it may be distributed amongst a number of computers.

Furthermore, embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1-39. (canceled)

40. A method comprising:
determining, by a user equipment, a trained generic model to perform or assist with performing a machine learning-enabled generic task;
determining, based on the trained generic model, one or more generic model-based outputs based on one or more signals or inputs;
transmitting, by the user equipment to a network node, the one or more generic model-based outputs;
receiving, by the user equipment from the network node based at least in part on the one or more generic model-based outputs, a request for a sub-task specific model, including configuration parameters for the sub-task specific model, wherein the sub-task specific model is to perform or assist with performing a machine learning-enabled sub-task;
verifying the request for the sub-task specific model;
modifying, by the user equipment, the sub-task specific model based on the trained generic model and the configuration parameters of the sub-task or the sub-task specific model;
performing or executing, by the user equipment, a machine learning-enabled sub-task based on or using the modified sub-task specific model; and
transmitting, by the user equipment to the network node, sub-task specific model outputs based on the performing or executing the machine learning-enabled sub-task based on or using the modified sub-task specific model.

41. The method of claim 40, wherein the modifying comprises at least one of:
modifying one or more weights of the sub-task specific model;
training the sub-task specific model;
re-training the sub-task specific model;
configuring or updating one or more weights or parameters of the sub-task specific model; or
upgrading or downgrading the sub-task specific model.

42. The method of claim 40, wherein the verifying the request for the sub-task specific model comprises:
verifying at least one of the following for the sub-task specific model:
the requested sub-task specific model is on a list of permitted sub-task specific models;
a threshold amount of training data and/or input signals are available for training the sub-task specific model; or
a threshold amount of processor resources and/or memory resources are available for training and/or using of the sub-task specific model.

43. The method of claim 40, wherein the receiving a request for a sub-task specific model, including configuration parameters for the sub-task specific model comprises receiving:
a trigger indication to trigger or cause sub-task specific model meta-learning or training, and one or more parameters of a sub-task or a sub-task specific model to be used for training the sub-task specific model based on the generic model, including receiving sub-task parameterization including constraints of the sub-task specific model or a sub-task specific cost function of the sub-task specific model.

44. The method of claim 40, wherein the configuration parameters of the sub-task or the sub-task specific model comprise one or more constraints of the sub-task specific model, and wherein the modifying, by the user equipment, of the sub-task specific model based on the generic model comprises performing one or more of the following based on the generic model and one or more constraints of the sub-task specific model:
pruning, or reducing a size of, the generic model so that the sub-task specific model will fit within a maximum allowed sub-task specific model depth or size;
deactivating one or more inputs of the generic model so that inputs of the sub-task specific model depth or size will fit a format, size or depth of the training data received from the one or more sub-task specific model collectors;
replacing a generic model activation function with a sub-task specific model-specific activation function; or
defining a sub-task specific model-specific cost function.

45. The method of claim 40, wherein the determining one or more generic model-based outputs comprises:
receiving, by the user equipment from the network node, a request to train a generic model for the machine learning-enabled generic task;
training, by the user equipment, the generic model based on a configuration or inputs received from the network node; and
performing or executing the machine learning-enabled generic task using the trained generic model to obtain the one or more generic model-based outputs.

46. The method of claim 45, wherein the request for a sub-task specific model is received by the user equipment in response to transmitting, by the user equipment to the network node, the one or more generic model-based outputs of the trained generic model.

47. An apparatus comprising:
at least one processor; and
at least one memory including computer program code;
the at least one memory and the computer program code configured to, with the at least one processor, cause the apparatus at least to:
determine a trained generic model for performing or assist with performing a generic machine learning-enabled task;
determine, based on the trained generic model, one or more generic model-based outputs based on one or more signals or inputs;
transmit, to a network node, the one or more generic model-based outputs;
receive, from the network node based at least in part of the one or more generic model-based outputs, a request for a sub-task specific model, including configuration parameters for the sub-task specific model, wherein the sub-task specific model is to perform or assist with performing a machine learning-enabled sub-task;
verify the request for the sub-task specific model;
modify the sub-task specific model based on the trained generic model and the configuration parameters of the sub-task or the sub-task specific model;
perform or execute a machine learning-enabled sub-task based on or using the modified sub-task specific model; and
transmitting, to the network node, sub-task specific model outputs based on the performing or executing the machine learning-enabled sub-task based on or using the trained sub-task specific model.

48. The apparatus of claim 47, wherein the modifying comprises at least one of:
modifying one or more weights of the sub-task specific model;
training the sub-task specific model;
re-training the sub-task specific model;
configuring or updating one or more weights or parameters of the sub-task specific model; or
upgrading or downgrading the sub-task specific model.

49. The apparatus of claim 47, wherein the verifying the request for the sub-task specific model comprises the instructions, when executed with the at least one processor, cause the apparatus to:
verify at least one of the following for the sub-task specific model:
the requested sub-task specific model is on a list of permitted sub-task specific models;
a threshold amount of training data and/or input signals are available for training the sub-task specific model; or
a threshold amount of processor resources and/or memory resources are available for training and/or using of the sub-task specific model.

50. The apparatus of claim 47, wherein the receiving a request for a sub-task specific model, including configuration parameters for the sub-task specific model comprises the instructions, when executed with the at least one processor, cause the apparatus to:
receive a trigger indication to trigger or cause sub-task specific model meta-learning or training, and one or more parameters of a sub-task or a sub-task specific model to be used for training the sub-task specific model based on the generic model, including receiving sub-task parameterization including constraints of the sub-task specific model or a sub-task specific cost function of the sub-task specific model.

51. The apparatus of claim 47, wherein the configuration parameters of the sub-task or the sub-task specific model comprise one or more constraints of the sub-task specific model, and wherein the modifying of the sub-task specific model based on the generic model comprises the instructions, when executed with the at least one processor, cause the apparatus to:
perform one or more of the following based on the generic model and one or more constraints of the sub-task specific model:
pruning, or reducing a size of, the generic model so that the sub-task specific model will fit within a maximum allowed sub-task specific model depth or size;
deactivating one or more inputs of the generic model so that inputs of the sub-task specific model depth or size will fit a format, size or depth of the training data received from the one or more sub-task specific model collectors;
replacing a generic model activation function with a sub-task specific model-specific activation function; or
defining a sub-task specific model-specific cost function.

52. The apparatus of claims 47, wherein the determining one or more generic model-based outputs comprises the instructions, when executed with the at least one processor, cause the apparatus to:
receive from the network node, a request to train a generic model for the machine learning-enabled generic task;
train the generic model based on a configuration or inputs received from the network node; and
perform or execute the machine learning-enabled generic task using the trained generic model to obtain the one or more generic model-based outputs.

53. The apparatus of claim 52, wherein the request for a sub-task specific model is received in response to transmitting to the network node, the one or more generic model-based outputs of the trained generic model.

54. An apparatus comprising:
at least one processor; and
at least one memory including computer program code;
the at least one memory and the computer program code configured to, with the at least one processor, cause the apparatus at least to:
determin a trained generic model to perform or assist with performing a machine learning-enabled generic task;
provid, to a user equipment, the trained generic model;
receive, from the user equipment, a request for a sub-task specific model;
verify the request for the sub-task specific model;
transmit, to the user equipment, a request for at least one of sub-task specific model configuration or constraints and/or sub-task specific model training data;
receive, from the user equipment, at least one of sub-task specific model configuration or constraints and/or sub-task specific model training data;
modify the sub-task specific model based on the generic model, and at least one of the sub-task specific model configuration or constraints and/or sub-task specific model training data; and
transmit, to the user equipment, the modified sub-task specific model.

55. The apparatus of claim 54, wherein the modifying comprises at least one of:
modifying one or more weights of the sub-task specific model;
training the sub-task specific model;
re-training the sub-task specific model;
configuring or updating one or more weights or parameters of the sub-task specific model; or
upgrading or downgrading the sub-task specific model.

56. The apparatus of claim 54, wherein the verifying the request for the sub-task specific model comprises the instructions, when executed with the at least one processor, cause the apparatus to:
verify at least one of the following for the sub-task specific model:
the requested sub-task specific model is on a list of permitted sub-task specific models;
a threshold amount of training data and/or input signals are available for training the sub-task specific model; or
a threshold amount of processor resources and/or memory resources are available for training and/or using of the sub-task specific model.

57. The apparatus of claim 54, wherein the modifying of the sub-task specific model based on the generic model comprises the instructions, when executed with the at least one processor, cause the apparatus to:
perform one or more of the following based on the generic model and one or more constraints of the sub-task specific model:
pruning, or reducing a size of, the generic model so that the sub-task specific model will fit within a maximum allowed sub-task specific model depth or size;
deactivating one or more inputs of the generic model so that inputs of the sub-task specific model depth or size will fit a format, size or depth of the training data received from the one or more sub-task specific model collectors;
replacing a generic model activation function with a sub-task specific model-specific activation function; or
defining a sub-task specific model-specific cost function.
